(19) United States
(12) Patent Application Publication
(10) Pub. No.: US 2013/0295287 A1
(43) Pub. Date: Nov. 7, 2013

(54) COMPOSITION FOR FORMING LAYER TO BE PLATED, AND PROCESS FOR PRODUCING LAMINATE HAVING METAL FILM

(71) Applicant: FUJIFILM Corporation, Tokyo (JP)

(72) Inventor: Naoki TSUKAMOTO, Ashigara-kami-gun (JP)

(21) Appl. No.: 13/935,816

(22) Filed: Jul. 5, 2013

Related U.S. Application Data
(63) Continuation of application No. PCT/JP2011/079005, filed on Dec. 15, 2011.

(30) Foreign Application Priority Data
Jan. 7, 2011 (JP) 2011-002544

(51) Int. Cl. C09D 135/02

(52) U.S. Cl. CPC C09D 135/02
USPC 427/304; 524/555; 524/554; 522/33

(57) ABSTRACT

A composition for forming a layer to be plated comprises a compound represented by formula (1):

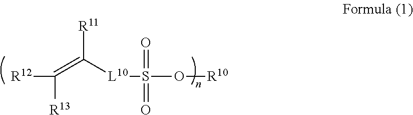

(In formula (1), R¹⁰ represents a hydrogen atom, a metal cation or a quaternary ammonium cation, L¹⁰ represents a single bond or a divalent organic group, R¹¹ to R¹³ each independently represent a hydrogen atom or an optionally substituted alkyl group, and n represents 1 or 2); and a polymer having a polymerizable group.

### BACKGROUND OF THE INVENTION

The present invention relates to a composition for forming a layer to be plated, and a process for producing a laminate having a metal film using the composition.

Metal circuit boards having patterned metal interconnects formed on a surface of an insulating substrate have heretofore been widely used in electronic components and semiconductor devices.

A “subtractive process” is mainly used to produce the patterned metal materials. The subtractive process is a process which involves forming a photosensitive layer that may be sensitized by irradiation with actinic rays on a metal film formed on a surface of a substrate, imagewise exposing the photosensitive layer, developing the exposed photosensitive layer to form a resist image, etching the metal film to form a metal pattern and finally peeling off the resist.

In the metal pattern obtained by this process, the adhesion between the substrate and the metal pattern (metal film) is achieved by the anchor effect produced by forming irregularities at the surface of the substrate. Therefore, when used as metal interconnects, the resulting metal pattern suffered from poor high frequency characteristics due to the irregularities at the interface between the metal pattern and the substrate. Further, the surface of the substrate needs to be treated with a strong acid such as chromic acid for roughening and therefore, a complicated process is necessary to obtain a metal pattern having excellent adhesion between the metal film and the substrate.

As a means to solve this problem, a method described in JP 2010-248464 A is known which involves forming on a substrate a polymer layer having high adhesion to the substrate, plating the polymer layer to obtain a metal film and etching the metal film. This method enables the adhesion between the substrate and the metal film to be improved without roughening the surface of the substrate.

### SUMMARY OF THE INVENTION

On the other hand, further shortening of the production process has been recently required in terms of the reduction of product costs.

The inventors of the invention have made a study on the patterned metal material disclosed in JP 2010-248464 A and as a result it was necessary to further improve the deposition rate of the film formed by electroless plating because the deposition time in the electroless plating was long.

In addition, with the increased demands in recent years for miniaturization and higher functionality of electronic devices, printed circuit boards and other micro wiring are formed at still higher levels of integration. Since then, further improvement of the adhesion of interconnects (metal film) to the substrate is required.

The inventors of the invention have made a study on the patterned metal material disclosed in JP 2010-248464 A and as a result it was found that the adhesion of the film obtained by plating (metal film) does not necessarily reach the level nowadays required.

As a result of shortening of the electroless plating time, the thickness of the metal film in the anchor portions usually tends to be thinner, leading to poor adhesion. In order to ensure a sufficient thickness of the metal film, the plating time is to be increased to reduce the productivity. The shortening of the plating time thus often has a trade-off relation with the improvement of the adhesion of the metal film.

The present invention aims at providing a composition for forming a layer to be plated which is capable of improving the plating rate during the electroless plating and of obtaining a metal film with further improved adhesion to a substrate, and a process for producing a laminate having the metal film which is performed using the foregoing composition.

The inventors of the invention have made an intensive study for solving the above problems, and as a result found that the problems can be solved by using a monomer having a sulfonate group. Accordingly, the inventors of the invention have found that the problems can be solved by the characteristic features as described below.

(1) A composition for forming a layer to be plated, comprising: a compound represented by formula (1) to be described below; and a polymer having a polymerizable group.

(2) The composition for forming the layer to be plated according to (1), wherein a weight ratio between a weight (weight A) of the compound and a total weight of the weight (weight A) of the compound and a weight (weight B) of the polymer (weight A+weight B) {weight A/(weight A+weight B)} is from 0.01 to 0.25.

(3) The composition for forming the layer to be plated according to (1) or (2), wherein a weight ratio between a weight (weight A) of the compound and a total weight of the weight (weight A) of the compound and a weight (weight B) of the polymer (weight A+weight B) {weight A/(weight A+weight B)} is from 0.05 to 0.20.

(4) The composition for forming the layer to be plated according to any one of (1) to (3), further comprising a polyfunctional monomer.

(5) The composition for forming the layer to be plated according to any one of (1) to (4), further comprising a polymerization initiator.

(6) A process for producing a laminate having a metal film, comprising:

a layer forming step including contacting the composition for forming the layer to be plated according to any one of (1) to (5) with a substrate and then applying energy to the composition for forming the layer to be plated to form the layer to be plated on the substrate;

a catalyst applying step including applying an electroless plating catalyst or its precursor to the layer to be plated; and

a plating step including subjecting the plating catalyst or its precursor to electroless plating to form the metal film on the plated layer.

(7) The process for producing the laminate having the metal film according to (6), wherein a surface of the substrate has a water contact angle of up to 80°.

(8) A layer to be plated obtained using the composition for forming the layer to be plated according to any one of (1) to (5).

The invention can provide a composition for forming a layer to be plated which is capable of improving the plating rate during the electroless plating and of obtaining a metal film with further improved adhesion to a substrate, and a process for producing a laminate having the metal film which is performed using the foregoing composition.

### BRIEF DESCRIPTION OF THE DRAWINGS

FIGS. 1A to 1D are schematic cross-sectional views showing from a substrate to a laminate and illustrating in order the laminate of the invention and respective production steps in a process for producing the laminate having a patterned metal film.

FIGS. 2A to 2D are schematic cross-sectional views illustrating in order an embodiment of a laminate etching step according to the invention.

FIGS. 3A to 3E are schematic cross-sectional views illustrating in order another embodiment of the laminate etching step according to the invention.

FIGS. 4A to 4H are schematic cross-sectional views illustrating in order production steps of a multilayer circuit board.

### DETAILED DESCRIPTION OF THE INVENTION

A composition for forming a layer to be plated, and a process for producing a laminate having a metal film according to the invention are described below.

The characteristic features of the invention compared to the prior art are first described in detail.

The invention is characterized by the use of a compound represented by formula (1) (hereinafter also referred to as a “sulfonate group-containing monomer” where appropriate). In cases where the sulfonate group-containing monomer is used to prepare a layer to be plated (polymer layer), the potential state of the surface of a substrate at which an electroless plating catalyst (e.g., palladium catalyst) is adsorbed onto a sulfonate group is favorable to perform electroless plating. Therefore, compared to the prior art, a higher plating rate is achieved while shortening the production process. In addition, the sulfonate group contained in the layer to be plated promotes the penetration of the plating solution, resulting in formation of a metal film having more excellent adhesion.

As compared to the prior art, the use of the layer to be plated according to the invention facilitates the detachment of the electroless plating catalyst through etching during the interconnect patterning and therefore upon removal of the layer to be plated through ashing treatment or the like, the layer to be plated can be removed more finely in a shorter time, consequently leading to further improvement of the insulation properties between the patterned interconnects.

The constituents of the composition for forming the layer to be plated according to the invention (the compound represented by formula (1) and a polymer having a polymerizable group) are first described in detail and then the process for producing the laminate having the metal film using the above composition is described in detail.

<Compound Represented by Formula (1)>

The composition for forming the layer to be plated according to the invention contains the compound represented by formula (1). As described above, by the inclusion of the compound, the electroless plating catalyst or its precursor is adsorbed onto the sulfonate group of the compound, whereby the substrate potential is likely to be equal to the mixed potential of the electroless plating solution and therefore the improvement of the plating deposition properties and the improvement of the adhesion of the metal film are achieved.

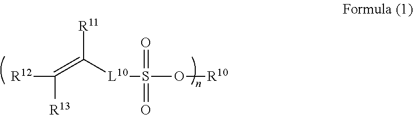

In formula (1), R¹⁰ represents a hydrogen atom, a metal cation or a quaternary ammonium cation. Examples of the metal cation include alkali metal cations (sodium ion and calcium ion), copper ion, palladium ion and silver ion. Monovalant or divalent metal cations are mainly used and when a divalent metal cation (e.g., palladium ion) is used, n to be referred to later represents 2.

Examples of the quaternary ammonium cation include tetramethylammonium ion and tetrabutylammonium ion.

Of these, R¹⁰ is preferably a hydrogen atom in terms of the adhesion of the electroless plating catalyst metal and the metallic residue after patterning.

L¹⁰ represents a single bond or a divalent organic group. Examples of the divalent organic group include an optionally substituted aliphatic hydrocarbon group (preferably containing 1 to 8 carbon atoms), an optionally substituted aromatic hydrocarbon group (preferably containing 6 to 12 carbon atoms), —O—, —S—, —SO₂—, —N(R)— (R: alkyl group), —CO—, —NH—, —COO—, —CONH—, and combination groups thereof (e.g., alkyleneoxy group, alkyleneoxycarbonyl group and alkylenecarbonyloxy group).

Preferred examples of the optionally substituted aliphatic hydrocarbon group include methylene group, ethylene group, propylene group and butylene group optionally substituted with methoxy group, chlorine atom, bromine atom, fluorine atom or the like.

Preferred examples of the optionally substituted aromatic hydrocarbon group include phenylene group optionally substituted with methoxy group, chlorine atom, bromine atom, fluorine atom or the like.

R¹¹ to R¹³ each independently represent a hydrogen atom or an optionally substituted alkyl group. Examples of the unsubstituted alkyl group include methyl group, ethyl group, propyl group and butyl group. Examples of the substituted alkyl group include methyl group, ethyl group, propyl group and butyl group substituted with methoxy group, chlorine atom, bromine atom, fluorine atom or the like.

R¹¹ is preferably a hydrogen atom or a methyl group.

R¹² is preferably a hydrogen atom.

R¹³ is preferably a hydrogen atom.

n represents an integer of 1 or 2. Of these, n is preferably 1 in terms of the availability of the compound.

### PREFERRED EMBODIMENTS

A preferred embodiment of the compound represented by formula (1) is a compound represented by formula (2).

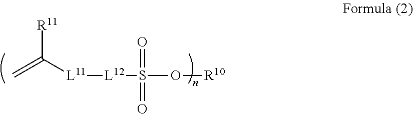

In formula (2), R¹⁰, R¹¹ and n are as defined above.

L¹¹ represents an ester group (—COO—), an amide group (—CONH—) or a phenylene group. Particularly when L¹¹ is an amide group, the polymerizability and the solvent resistance (e.g., the resistance to alkaline solvents) in the resulting layer to be plated are improved.

L¹² represents a single bond, a divalent aliphatic hydrocarbon group (containing preferably 1 to 8 carbon atoms and more preferably 3 to 5 carbon atoms) or a divalent aromatic hydrocarbon group. The aliphatic hydrocarbon group may be linear, branched or cyclic.

When L¹² is a single bond, L¹¹ represents a phenylene group.

The molecular weight of the compound represented by formula (1) is not particularly limited and is preferably from 100 to 1,000 and more preferably from 100 to 300 in terms of the volatility, solubility in solvents, film formability and ease of handling.

<Polymer Having Polymerizable Group>

The polymer that may be used in the invention has a polymerizable group.

The functional groups that may be contained in the polymer and their characteristics are described below in detail.

(Polymerizable Group)

The polymerizable group is a functional group capable of forming a chemical bond between polymers or a polymer and a substrate (or an adhesion promoting layer) by application of energy, and examples thereof include a radical polymerizable group and a cationic polymerizable group. Of these, the radical polymerizable group is preferable in terms of the reactivity. Examples of the radical polymerizable group include unsaturated carboxylic ester groups such as acrylic ester group, methacrylic ester group, itaconic ester group, crotonic ester group, isocrotonic ester group and maleic ester group; styryl group, vinyl group, acrylamide group and methacrylamide group. Of these, methacrylic ester group, acrylic ester group, vinyl group, styryl group, acrylamide group and methacrylamide group are preferable and methacrylic ester group, acrylic ester group and styryl group are most preferable.

(Interactive Group)

The polymer preferably has a functional group that may interact with the electroless plating catalyst to be described later or its precursor (this group is hereinafter also referred to as an “interactive group” where appropriate). In the presence of the group, the potential at the surface of the substrate having the layer to be plated onto which the electroless plating catalyst or its precursor is adsorbed is likely to be equal to the mixed potential of the electroless plating solution, and therefore the plating rate during the electroless plating is increased while further improving the adhesion of the resulting metal film.

The interactive group is a functional group (coordinating group or metal ion adsorbing group) which may interact with the electroless plating catalyst or its precursor, and a functional group capable of forming an electrostatic interaction with the electroless plating catalyst or its precursor, or a nitrogen-, sulfur- or oxygen-containing functional group capable of coordinating with the electroless plating catalyst or its precursor may be used.

An example of the interactive group includes a non-dissociative functional group (functional group in which no proton is generated by dissociation).

More specific examples of the interactive group include nitrogen-containing functional groups such as amino group, amide group, imide group, urea group, tertiary amino group, ammonium group, amidino group, triazine ring, triazole ring, benzotriazole group, imidazole group, benzimidazole group, quinoline group, pyridine group, pyrimidine group, pyrazine group, nazoline group, quinoxaline group, purine group, triazine group, piperidine group, piperazine group, pyrrolidine group, pyrazole group, aniline group, alkylamine structure-containing group, isocyanuric structure-containing group, nitro group, nitroso group, azo group, diazo group, azide group, cyano group, and cyanate group (R—O—CN); oxygen-containing functional groups such as ether group, hydroxyl group, phenolic hydroxyl group, carboxyl group, carbonate group, carbonyl group, ester group, N-oxide structure-containing group, S-oxide structure-containing group and N-hydroxy structure-containing group; sulfur-containing functional groups such as thiophene group, thiol group, thiourea group, thiocyanurate group, benzothiazole group, mercaptotriazine group, thioether group, thioxy group, sulfoxide group, sulfone group, sulfite group, sulfoximine structure-containing group, sulfoxinium salt structure-containing group, sulfonate group and sulfonic ester structure-containing group; phosphorus-containing functional groups such as phosphate group, phosphoramide group, phosphine group and phosphoric ester structure-containing group; groups containing halogen atoms such as chlorine and bromine. In a functional group that may have a salt structure, a salt thereof may also be used.

Of these, ionic polar groups such as carboxyl group, sulfonate group, phosphate group and boronate group, and ether group and cyano group are particularly preferable, and carboxyl group and cyano group are more particularly preferable because of their high polarity and high adsorptivity on an electroless plating catalyst or a precursor thereof.

Two or more types of functional groups which serve as interactive groups may be contained in the polymer.

A polyoxyalkylene group represented by the following formula (X):

*—(YO)ₙ—R^{c} Formula (X)

is preferable as the ether group.

In formula (X), Y represents an alkylene group and R^{c} represents an alkyl group. n represents a number of 1 to 30. * represents a bonding position.

The alkylene group preferably contains 1 to 3 carbon atoms and specific examples thereof include ethylene group and propylene group.

The alkyl group preferably contains 1 to 10 carbon atoms and specific examples thereof include methyl group and ethyl group.

n represents a number of 1 to 30 and preferably 3 to 23. n represents an average value, which can be measured by a known method such as NMR.

The weight-average molecular weight of the polymer is not particularly limited and is preferably at least 1,000 but not more than 700,000 and more preferably at least 2,000 but not more than 200,000. The weight-average molecular weight is most preferably 20,000 or more in terms of the polymerization sensitivity.

The degree of polymerization of the polymer is not particularly limited and it is preferable to use a polymer having a degree of polymerization of at least 10 and more preferably at least 20. The degree of polymerization is preferably up to 7,000, more preferably up to 3,000, even more preferably up to 2,000 and most preferably up to 1,000.

### Preferred Embodiment 1

A first preferred embodiment of the polymer is a copolymer containing a polymerizable group-containing unit represented by formula (a) shown below (hereinafter also referred to as a “polymerizable group unit” where appropriate) and an interactive group-containing unit represented by formula (b) shown below (hereinafter also referred to as an “interactive group unit” where appropriate). The unit denotes a recurring unit.

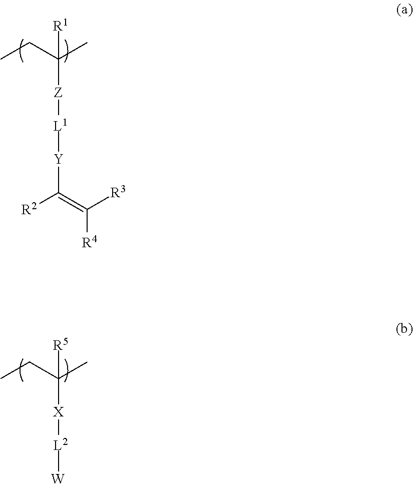

In formulas (a) and (b), R¹ to R⁵ each independently represent a hydrogen atom or an optionally substituted alkyl group.

When R¹ to R⁵ are each an optionally substituted alkyl group, exemplary unsubstituted alkyl groups include methyl group, ethyl group, propyl group and butyl group. Examples of the substituted alkyl group include methyl group, ethyl group, propyl group and butyl group substituted with methoxy group, chlorine atom, bromine atom, fluorine atom or the like.

R¹ is preferably a hydrogen atom or a methyl group optionally substituted with a bromine atom.

R² is preferably a hydrogen atom or a methyl group optionally substituted with a bromine atom.

R³ is preferably a hydrogen atom.

R⁴ is preferably a hydrogen atom.

R⁵ is preferably a hydrogen atom or a methyl group optionally substituted with a bromine atom.

In formulas (a) and (b), X, Y and Z each independently represent a single bond or an optionally substituted divalent organic group. Examples of the divalent organic group include an optionally substituted aliphatic hydrocarbon group (preferably containing 1 to 8 carbon atoms), an optionally substituted aromatic hydrocarbon group (preferably containing 6 to 12 carbon atoms), —O—, —S—, —SO₂—, —N(R)— (R: alkyl group), —CO—, —NH—, —COO—, —CONH—, and combination groups thereof (e.g., alkyleneoxy group, alkyleneoxycarbonyl group and alkylenecarbonyloxy group).

Preferred examples of the optionally substituted aliphatic hydrocarbon group include methylene group, ethylene group, propylene group and butylene group optionally substituted with methoxy group, chlorine atom, bromine atom, fluorine atom or the like.

Preferred examples of the optionally substituted aromatic hydrocarbon group include phenylene group optionally substituted with methoxy group, chlorine atom, bromine atom, fluorine atom or the like.

X, Y and Z are each preferably a single bond, an ester group (—COO—), an amide group (—CONH—), an ether group (—O—) or an optionally substituted aromatic hydrocarbon group, and more preferably a single bond, an ester group (—COO—), or an amide group (—CONH—).

In formulas (a) and (b), L¹ and L² each independently represent a single bond or an optionally substituted divalent organic group. The divalent organic group is as defined above for the divalent organic group mentioned on X, Y and Z.

L¹ is preferably an aliphatic hydrocarbon group or a divalent organic group (e.g., an aliphatic hydrocarbon group) having a urethane bond or a urea bond, more preferably a divalent organic group having a urethane bond, and most preferably contains in total 1 to 9 carbon atoms. The total number of carbon atoms in L¹ refers to the total number of carbon atoms included in the optionally substituted divalent organic group represented by L¹.

More specifically, L¹ preferably has a structure represented by formula (1-1) or (1-2).

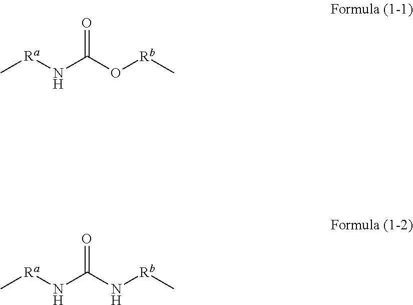

In formulas (1-1) and (1-2), R^{a} and R^{b} are each independently a divalent organic group formed with at least two atoms selected from the group consisting of carbon atom, hydrogen atom and oxygen atom. Preferred examples thereof include optionally substituted methylene, ethylene, propylene and butylene groups, ethylene oxide group, diethylene oxide group, triethylene oxide group, tetraethylene oxide group, dipropylene oxide group, tripropylene oxide group, and tetrapropylene oxide group.

L² is preferably a single bond, a linear, branched or cyclic alkylene group, an aromatic group, or a combination group thereof. The combination group of the alkylene group and the aromatic group may be further formed via an ether group, an ester group, an amide group, a urethane group or a urea group. In particular, it is preferable for L² to be a single bond or contain in total 1 to 15 carbon atoms. Most preferably, L² is unsubstituted. The total number of carbon atoms in L² refers to the total number of carbon atoms included in the optionally substituted divalent organic group represented by L².

Specific examples thereof include methylene group, ethylene group, propylene group, butylene group and phenylene group which may be optionally substituted with methoxy group, hydroxy group, chlorine atom, bromine atom, fluorine atom or the like, and combination groups thereof.

In formula (b), W represents a functional group that may interact with the electroless plating catalyst or its precursor. The functional group is as defined above for the interactive group.

A preferred embodiment of the polymerizable group unit represented by formula (a) is a unit represented by formula (c).

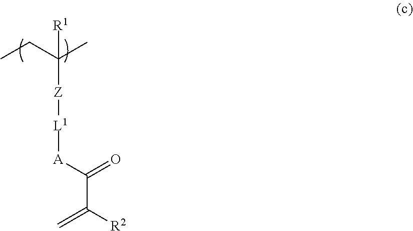

In formula (c), R¹, R², Z and L¹ are as defined for the respective groups in the unit represented by formula (a); and A represents an oxygen atom or NR (where R is a hydrogen atom or an alkyl group and preferably a hydrogen atom or an unsubstituted alkyl group containing 1 to 5 carbon atoms).

A preferred embodiment of the unit represented by formula (c) is a unit represented by formula (d).

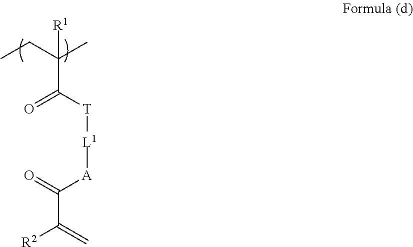

In formula (d), R¹, R² and L¹ are as defined for the respective groups in the unit represented by formula (a); and A and T represent an oxygen atom or NR (where R is a hydrogen atom or an alkyl group and preferably a hydrogen atom or an unsubstituted alkyl group containing 1 to 5 carbon atoms).

In formula (d), T is preferably an oxygen atom.

In formulas (c) and (d), L¹ is preferably an unsubstituted alkylene group or a divalent organic group having a urethane bond or a urea bond, more preferably a divalent organic group having a urethane bond, and most preferably contains in total 1 to 9 carbons.

A preferred embodiment of the interactive group unit represented by formula (b) is a unit represented by formula (e).

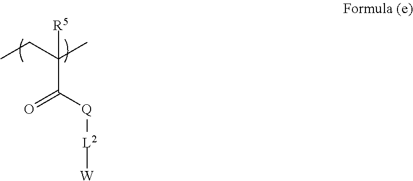

In formula (e), R⁵ and L² are as defined for the respective groups in the unit represented by formula (2); and Q is an oxygen atom or NR′ (where R′ is a hydrogen atom or an alkyl group and preferably a hydrogen atom or an unsubstituted alkyl group containing 1 to 5 carbon atoms).

In formula (e), L² is preferably a linear, branched or cyclic alkylene group, an aromatic group, or a combination group thereof.

Particularly in formula (e), the linkage moiety of L² with the interactive group is preferably a divalent organic group having a linear, branched or cyclic alkylene group and the divalent organic group more preferably contains in total 1 to 10 carbon atoms.

In another preferred embodiment, the linkage moiety of L² with the interactive group in formula (e) is preferably a divalent organic group having an aromatic group and the divalent organic group more preferably contains in total 6 to 15 carbon atoms.

The polymerizable group unit is preferably contained in an amount of 5 to 50 mol % and more preferably 5 to 40 mol % with respect to all the units in the polymer. An amount of less than 5 mol % may reduce the reactivity (curing properties, polymerizability), whereas an amount exceeding 50 mol % facilitates gelation during synthesis and hinders the synthesis.

The interactive group unit is preferably contained in an amount of 5 to 95 mol % and more preferably 10 to 95 mol % with respect to all the units in the polymer in terms of the adsorptivity on the electroless plating catalyst or its precursor.

### Preferred Embodiment 2

A second preferred embodiment of the polymer is a copolymer containing the units represented by formulas (A), (B) and (C).

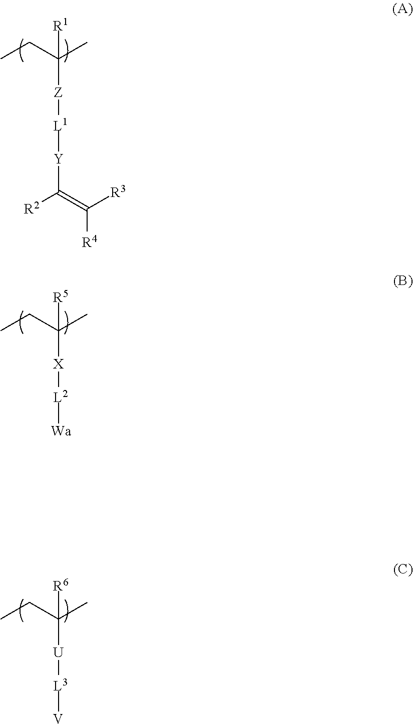

The unit represented by formula (A) is the same as the unit represented by formula (a), and the description of the respective groups is also the same.

R⁵, X and L² in the unit represented by formula (B) are the same as R⁵, X and L² in the unit represented by formula (b), and the description of the respective groups is also the same.

Wa in formula (B) represents a functional group that may form an interaction with the electroless plating catalyst or its precursor and which excludes a hydrophilic group represented by V to be referred to below or its precursor group.

In formula (C), R⁶ each independently represents a hydrogen atom or an optionally substituted alkyl group. The alkyl group is as defined above for the alkyl groups represented by R¹ to R⁵.

In formula (C), U represents a single bond or an optionally substituted divalent organic group. The divalent organic group is as defined above for the divalent organic groups represented by X, Y and Z.

In formula (C), L³ represents a single bond or an optionally substituted divalent organic group. The divalent organic group is as defined above for the divalent organic groups represented by L¹ and L².

In formula (C), V represents a hydrophilic group or its precursor group. The hydrophilic group is not particularly limited as long as it is a group having hydrophilicity. Examples thereof include hydroxyl group and carboxylate group. The precursor group of the hydrophilic group refers to a group which generates the hydrophilic group through a predetermined treatment (e.g., treatment with an acid or an alkali), and an exemplary precursor group is carboxy group protected by THP (2-tetrahydropyranyl group).

The hydrophilic group is preferably an ionic polar group because the wettability of the layer to be plated with various aqueous treatment solutions or plating solutions is enhanced. Specific examples of the ionic polar group include carboxylate group, sulfonate group, phosphate group, and boronate group. Of these, carboxylate group is preferable in terms of the moderate acidity at which the other functional groups are not decomposed.

In the unit represented by formula (C), an embodiment in which V is a carboxylate group and a 4- to 8-membered ring structure is present in the linkage moiety of L³ with V is preferred in terms of the moderate acidity (causing no decomposition of the other functional groups), hydrophilicity shown in an aqueous alkali solution, and hydrophobicity easily shown upon dehydration due to the cyclic structure. Examples of the 4- to 8-membered ring structure include cyclobutyl group, cyclopentyl group, cyclohexyl group, cycloheptyl group, cyclooctyl group, and phenylene group. Of these, cyclohexyl group and phenylene group are preferred.

In the unit represented by formula (C), an embodiment in which V is a carboxylate group and L³ has a chain length of 6 to 18 atoms is also preferred in terms of the moderate acidity (causing no decomposition of the other functional groups), hydrophilicity shown in an aqueous alkali solution, and hydrophobicity easily shown upon dehydration due to the long-chain alkyl group structure. The chain length of L³ refers to a distance between U and V in formula (C) and means that U is preferably spaced apart from V by a distance of 6 to 18 atoms. L³ has a chain length of more preferably 6 to 14 atoms and even more preferably 6 to 12 atoms.

The preferable contents of the respective units in the second preferred embodiment of the polymer are as follows:

The unit represented by formula (A) is preferably contained in an amount of 5 to 50 mol % and more preferably 5 to 30 mol % with respect to all the units in the polymer in terms of the reactivity (curing properties and polymerizability) and the suppression of the gelation during the synthesis.

The unit represented by formula (B) is preferably contained in an amount of 5 to 75 mol % and more preferably 10 to 70 mol % with respect to all the units in the polymer in terms of the adsorptivity on the electroless plating catalyst or its precursor.

The unit represented by formula (C) is preferably contained in an amount of 10 to 70 mol %, more preferably 20 to 60 mol % and most preferably 30 to 50 mol % with respect to all the units in the polymer in terms of the developability with an aqueous solution and resistance to wet adhesion.

The ionic polarity value in the second preferred embodiment of the polymer (the acid number in cases where the ionic polar group is carboxylate group) is preferably from 1.5 to 7.0 mmol/g, more preferably from 1.7 to 5.0 mmol/g and most preferably from 1.9 to 4.0 mmol/g. When the ionic polarity value is within these ranges, the developability with an aqueous solution can be achieved while simultaneously suppressing the temporal reduction of the adhesion force upon wet heating.

Specific examples of the polymer that may be used as the polymer having a radical polymerizable group and a functional group which may form an interaction with the electroless plating catalyst or its precursor include polymers described in paragraphs [0106] to [0112] of JP 2009-007540 A. Examples of the polymer that may be used as the polymer having a radical polymerizable group and an ionic polar group include polymers described in paragraphs [0065] to [0070] of JP 2006-135271A. Examples of the polymer that may be used as the polymer having a radical polymerizable group, a functional group which may form an interaction with the electroless plating catalyst or its precursor, and an ionic polar group include polymers described in paragraphs [0030] to [0108] of US 2010-080964A.

The following polymers may also be used.

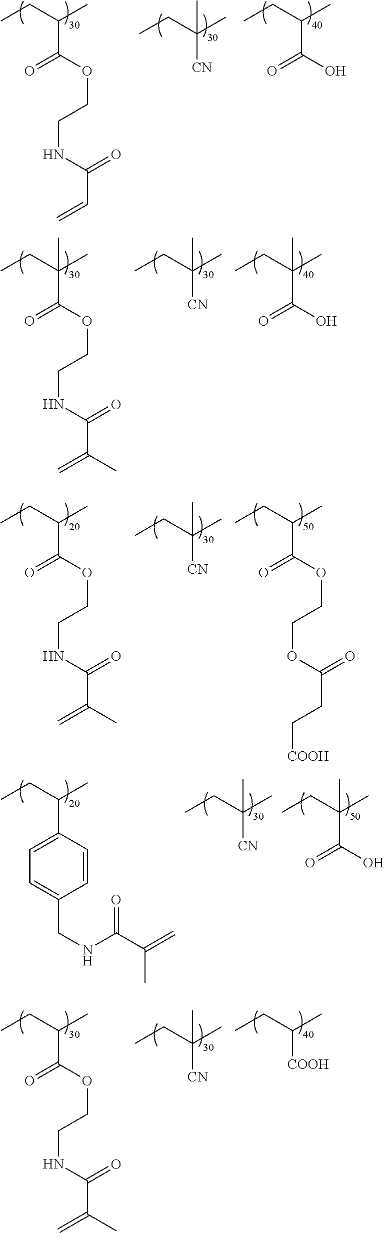

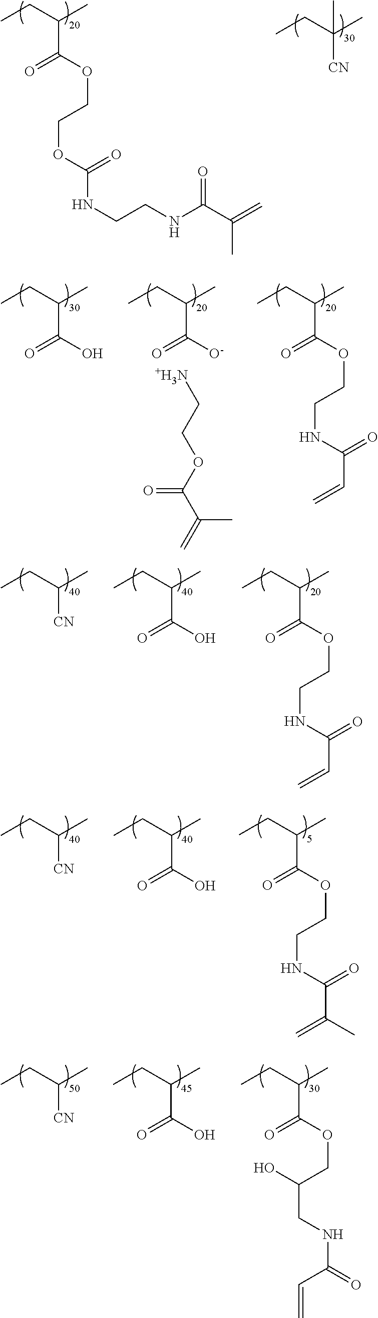

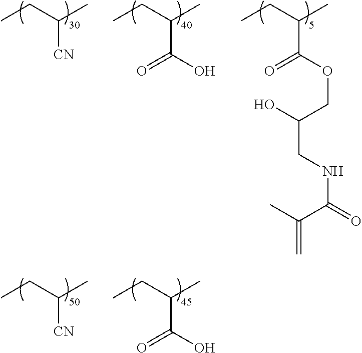

(Polymer Synthesis Method)

The polymer synthesis method is not particularly limited and the monomer used may be a commercial product or a product synthesized by a combination of known synthesis methods. The polymer may be synthesized, for example, according to the method described in paragraphs [0120] to [0164] of JP 2009-7662 A.

More specifically, when the polymerizable group is a radical polymerizable group, the polymer is preferably synthesized by the following methods:

i) A method in which a monomer having a radical polymerizable group and a monomer having an interactive group are copolymerized; ii) a method in which a monomer having an interactive group and a monomer having a radical polymerizable group precursor are copolymerized and a radical polymerizable group is then introduced by a treatment with a base or the like; and iii) a method in which a monomer having an interactive group and a monomer having a reactive group to introduce a radical polymerizable group are copolymerized to introduce the radical polymerizable group.

The methods ii) and iii) are preferred in terms of the synthesis suitability. The type of the polymerization reaction during the synthesis is not particularly limited and the radical polymerization is preferably used.

In cases where the copolymer containing the units represented by formulas (A), (B) and (C) is to be synthesized, a monomer having a hydrophilic group or its precursor group and a monomer having an interactive group except the hydrophilic group or its precursor may be used to synthesize a desired copolymer according to the methods i) to iii).

<Other Arbitrary Ingredients in Composition for Forming Layer to Be Plated>

### (Solvent)

The composition for forming the layer to be plated may optionally contain a solvent.

The solvent that may be used is not particularly limited and examples thereof include water; alcoholic solvents such as methanol, ethanol, propanol, ethylene glycol, glycerin and propylene glycol monomethyl ether; acids such as acetic acid; ketone solvents such as acetone, methyl ethyl ketone and cyclohexanone; amide solvents such as formamide, dimethylacetamide and N-methylpyrrolidone; nitrile solvents such as acetonitrile and propionitrile; ester solvents such as methyl acetate and ethyl acetate; and carbonate solvents such as dimethyl carbonate and diethyl carbonate. Other exemplary solvents include ether solvents, glycolic solvents, amine solvents, thiol solvents and halogen solvents.

Of these, amide solvents, ketone solvents, nitrile solvents, and carbonate solvents are preferable and more specifically acetone, dimethylacetamide, methyl ethyl ketone, cyclohexanone, acetonitrile, propionitrile, N-methylpyrrolidone and dimethyl carbonate are preferable.

(Polymerization Initiator)

The composition for forming the layer to be plated according to the invention may contain a polymerization initiator. By the inclusion of the polymerization initiator, the formation of the bond between the polymers, the bond between the polymer and the substrate and the bond between the polymer and the compound represented by formula (1) can be further promoted and as a result a metal film having more excellent adhesion can be obtained.

The polymerization initiator that may be used is not particularly limited and use may be made of, for example, thermal polymerization initiators, photopolymerization initiators (radical polymerization initiators, anionic polymerization initiators, cationic polymerization initiators), polymer compounds having an active carbonyl group on the side chain as described in JP 9-77891 A and JP 10-45927 A, and also polymers including a functional group having the polymerization initiating ability and a cross-linking group on the side chain (polymerization-initiating polymers).

Exemplary photopolymerization initiators include benzophenones, acetophenones, α-aminoalkylphenones, benzoins, ketones, thioxanthones, benzyls, benzyl ketals, oxime esters, anthrones, tetramethylthiuram monosulfides, bis(acyl)phosphine oxides, acylphosphine oxides, anthraquinones, azo compounds and derivatives thereof. The details are described in Ultraviolet Curing System (1989, United Engineering Center) pp. 63-147. A cationic polymerization initiator may also be used as the polymerization initiator for ring-opening polymerization. Examples of the cationic polymerization initiator include aromatic onium salts, sulfonium salts of Group VIa elements of the Periodic Table, and derivatives thereof.

Exemplary thermal polymerization initiators include diazo compounds and peroxide compounds.

(Monomer)

The composition for forming the layer to be plated according to the invention may contain a monomer other than the compound represented by formula (1). The crosslinking density in the layer to be plated can be appropriately controlled by the inclusion of the monomer.

Any monomer may be used without particular limitation and exemplary monomers include addition-polymerizable compounds such as ethylenically unsaturated bond-containing compounds and ring-opening polymerizable compounds such as epoxy group-containing compounds.

More specifically, unsaturated carboxylic acids (e.g., acrylic acid, methacrylic acid, itaconic acid, crotonic acid, isocrotonic acid and maleic acid), and esters and amides thereof are used and illustrative examples include compounds containing, for example, an acryloyl group, a methacryloyl group, an ethacryloyl group, an acrylamide group, an allyl group, a vinyl ether group or a vinyl thioether group.

More specifically, illustrative examples thereof include acrylic acid and salts thereof, acrylic esters, acrylamides, methacrylic acid and salts thereof, methacrylic esters, methacrylamides, maleic anhydride, maleic esters, itaconic esters, styrenes, vinyl ethers, vinyl esters, N-vinyl heterocycles, allyl ethers, allyl esters and derivatives thereof. Other examples include resins obtained by (meth)acrylating part of the resins such as epoxy resins, phenol resins, polyimide resins, polyolefin resins and fluororesins with methacrylic acid, acrylic acid or the like. These compounds may be used alone or in combination of two or more. A compound having one or more than one epoxy ring such as glycidyl acrylate may also be used.

In addition, these compounds may be monomers, oligomers or high molecular weight polymers.

Of these, a polyfunctional monomer is preferably used because the crosslinking density in the layer to be plated and the adhesion of the metal film are further improved. The polyfunctional monomer refers to a monomer having at least two polymerizable groups. More specifically, a monomer having 2 to 6 polymerizable groups is preferably used.

The polyfunctional monomer used preferably has a molecular weight of 150 to 1,000 and more preferably 200 to 700 in terms of the molecular mobility in the crosslinking reaction that may affect the reactivity. The polymerizable groups are preferably spaced apart from each other by a distance of 1 to 15 atoms and more preferably at least 6 but not more than 10 atoms.

It is also useful to select the polyfunctional monomer in terms of the reactivity and the compatibility with a binder used in combination (i.e., mainly the above-described polymer). In this regard, a polyfunctional monomer in which the solubility parameter as defined by the Okitsu method is close to that of the binder used in combination, more specifically a compound having a solubility parameter difference of ±5 MPa1/2 or less may also be selected and used.

(Other Additives)

Other additives (e.g., sensitizer, curing agent, polymerization inhibitor, antioxidant, antistatic agent, UV absorber, filler, particles, flame retardant, surfactant, lubricant and plasticizer) may be optionally added to the composition for forming the layer to be plated according to the invention.

<Composition for Forming Layer to be Plated>

The composition for forming the layer to be plated according to the invention contains the compound represented by formula (1) and the polymer having the polymerizable group.

The content of the compound represented by formula (1) in the composition for forming the layer to be plated is not particularly limited and is preferably from 0.01 to 10 wt % and more preferably from 0.01 to 2 wt % with respect to the total amount of the composition. When the compound content is within the above ranges, the composition is handled with ease and the resulting metal film has more excellent adhesion.

The content of the polymer in the composition for forming the layer to be plated is not particularly limited and is preferably from 2 to 50 wt % and more preferably from 5 to 30 wt % with respect to the total amount of the composition. When the polymer content is within the above ranges, the composition is handled with ease and the thickness of the layer to be plated is easily controlled.

The weight ratio between the weight (weight A) of the compound represented by formula (1) and the total weight of the weight A of the compound and the weight (weight B) of the polymer in the composition for forming the layer to be plated {weight A/(weight A+weight B)} is not particularly limited and is preferably from 0.01 to 0.66 in terms of the film formability, more preferably from 0.01 to 0.25 and even more preferably from 0.05 to 0.20 in terms of further improvement of the plating rate during the electroless plating and further improvement of the adhesion of the resulting metal film.

When the composition for forming the layer to be plated contains a solvent, the content of the solvent is preferably from 50 to 98 wt % and more preferably from 70 to 95 wt % with respect to the total amount of the composition. When the solvent content is within the above ranges, the composition is handled with ease and the thickness of the layer to be plated is easily controlled.

When the composition for forming the layer to be plated contains a polymerization initiator, the content of the polymerization initiator is preferably from 0.01 to 1 wt % and more preferably from 0.1 to 0.5 wt % with respect to the total amount of the composition. When the content is within the above ranges, the composition is handled with ease and the resulting metal film has more excellent adhesion.

When the composition for forming the layer to be plated contains a monomer other than the compound represented by formula (1) (in particular a polyfunctional monomer), the content of the monomer is preferably from 0.01 to 5 wt % and more preferably from 0.1 to 1 wt % with respect to the total amount of the composition. When the monomer content is within the above ranges, the composition is handled with ease and the resulting metal film has more excellent adhesion.

<Process for Producing Laminate Having Metal Film>

A laminate having a metal film can be produced by using the above-described composition for forming the layer to be plated. The production process mainly includes the following three steps:

(Layer forming step) a step which includes contacting the composition for forming the layer to be plated with a substrate and then applying energy to the composition for forming the layer to be plated to form the layer to be plated on the substrate;
(Catalyst applying step) a step which includes applying an electroless plating catalyst or its precursor to the layer to be plated; and
(Plating step) a step which includes subjecting the plating catalyst or its precursor to electroless plating to form the metal film on the plated layer.

The materials used in the respective steps and the operation methods are described below in detail.

### <Layer Forming Step>

The layer forming step is a step which includes contacting the composition for forming the layer to be plated with the substrate and then applying energy to the composition on the substrate for forming the layer to be plated to form the layer to be plated on the substrate. In the catalyst applying step to be described later, the electroless plating catalyst or its precursor is adsorbed onto (adhered to) the layer to be plated which is formed by this step according to the function of the sulfonate group contained in the compound represented by formula (1) and the interactive group optionally contained in the polymer. In other words, the layer to be plated serves as the good receptive layer of the electroless plating catalyst or its precursor. In addition, the polymerizable group is used for bonding between polymers or chemical bonding between the polymer and the substrate (or the adhesion promoting layer to be described later). As a result, excellent adhesion is obtained between the metal film formed on the surface of the plated layer (film obtained by plating) and the substrate.

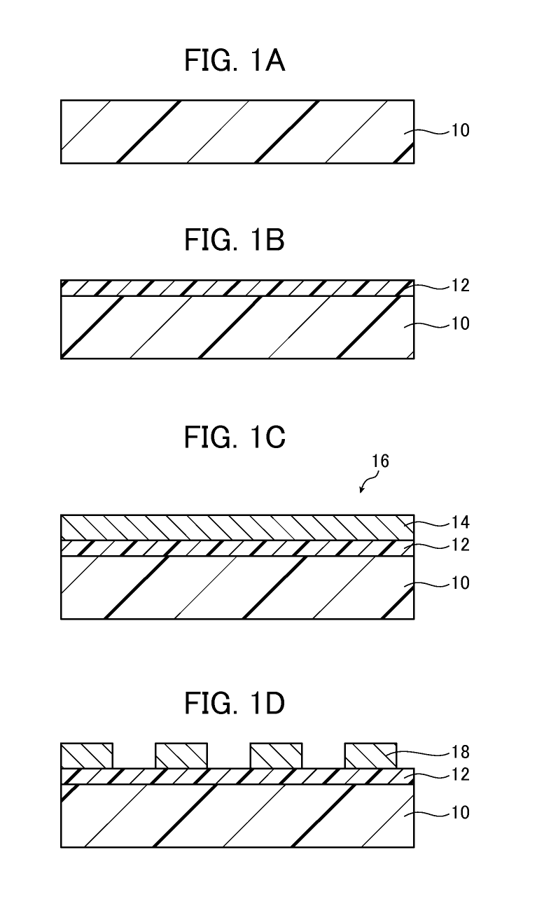

More specifically, in this step, a substrate 10 is prepared as shown in FIG. 1A and a layer to be plated 12 is formed on top of the substrate 10 as shown in FIG. 1B. As will be described later, the substrate 10 may have an adhesion promoting layer on its surface and in this case the layer to be plated 12 is formed on the adhesion promoting layer.

The materials (the substrate, the adhesion promoting layer and the like) used in this step are first described in detail and the procedure of this step is then described in detail.

(Substrate)

Any conventionally known substrate may be used as the substrate for use in the invention and a substrate capable of withstanding the treatment conditions to be referred to below is preferable. The surface of the substrate preferably has the function of chemically bonding to the polymer to be described below. More specifically, the substrate itself may form a chemical bond with the polymer by application of energy (e.g., exposure to light). Alternatively, an intermediate layer capable of forming a chemical bond with the layer to be plated by application of energy (e.g., the adhesion promoting layer to be described later) may be formed on the substrate.

The substrate surface preferably has a water contact angle of up to 80° and more preferably up to 60° because the formability of the composition for forming the layer to be plated is improved and the adhesion of the metal film is further improved. The lower limit is not particularly limited and is usually 0° or more.

The contact angle is measured by the tangent method using the top of a water droplet and two contact points with the substrate.

The substrate surface may be optionally subjected to any of various surface treatments (e.g., alkali treatment, plasma treatment, ozone treatment) so as to have the foregoing contact angle.

The substrate material is not particularly limited and the substrate may be formed from various materials including polymer materials (e.g., plastics described in “Notebook for Utilizing Plastics, fourth revised edition” and/or “Notebook for Utilizing Engineering Plastics”), metallic materials (e.g., metallic alloys, metal-containing materials, pure metals or similar materials thereto), other materials (e.g., paper, plastic laminated paper), combinations thereof, and similar materials thereto.

Plastic resins such as thermoplastic resins and thermosetting resins may be used and conventionally known commodity plastics and engineering plastics may be used.

Specific examples of the thermoplastic commodity plastics include polypropylene, polyethylene, polyisobutylene, polybutadiene, polyisoprene, cycloolefin resin, polyphenylene oxide, phenoxy resin, polyether, cellophane, ionomer, α-olefin polymer, ethylene-vinyl acetate copolymer, ethylene-ethyl acrylate copolymer, ethylene-propylene copolymer, polyvinyl chloride, polyvinylidene chloride, chlorinated polyethylene, chlorinated polypropylene, polyvinylidene fluoride, vinyl chloride-vinyl acetate copolymer, vinyl chloride-ethylene copolymer, vinyl chloride-vinylidene chloride copolymer, vinyl chloride-vinylidene chloride-vinyl acetate terpolymer, vinyl chloride-acrylic acid ester copolymer, vinyl chloride-maleic acid ester copolymer, vinyl chloride-cyclohexyl maleimide copolymer, petroleum resin, coal resin, rosin derivatives, coumarone-indene resin, terpene resin, coumarone resin, polystyrene, syndiotactic polystyrene, polyvinyl acetate, acrylic resin, copolymers of styrene and/or α-methylstyrene and other monomers (e.g., maleic anhydride, phenylmaleimide, methyl methacrylate, butadiene, acrylonitrile) (such as AS (acrylonitrile-styrene) resin, ABS (acrylonitrile-butadiene-styrene) resin), polyacrylate, polymethyl methacrylate, polyvinyl alcohol resin, vinyl resin, polyalkylene terephthalate, polyalkylene naphthalate, polyester resin, and 1,2-bis(vinylphenylene)ethane resin. Of these, ABS resin, polypropylene, polyvinyl chloride, acrylic resin and polyalkylene terephthalate are preferable.

Specific examples of the engineering plastics include thermoplastic resins such as polycarbonate, polyamide, polycaprolactam, polyacetal, polyimide, bismaleimide resin, polyetherimide, polyamide-imide resin, fluororesin, silicone resin, polyethersulfone, polysulfone, polyphenylene sulfone, polyphenylene sulfide, polyphenyl ether, polyphenylene ether, polyetherimide, polyether ketone, polyetheretherketone, liquid crystal polymer (more specifically, for example, VECSTAR manufactured by Kuraray Co., Ltd.), poly-paraphenylene terephthalamide (PPTA), polyarylate resin, polyoxymethylene resin, polymethylpentene resin and cellulose resin. Of these, polycarbonate, polyamide, polyimide and polyethersulfone and liquid crystal polymer are preferable.

In addition, exemplary rubber polymers that may be used include silicone rubber, diene rubbers such as isoprene rubber, butadiene rubber, acrylonitrile-butadiene copolymer rubber (NBR), and styrene-butadiene copolymer rubber (SBR); elastomers such as fluororubber, silicone rubber, olefinic elastomer, styrene elastomer, polyester elastomer, nitrile elastomer, nylon elastomer, chlorinated rubber, vinyl chloride elastomer, polyamide elastomer, and polyurethane elastomer; acrylic rubbers such as poly(butyl acrylate) and poly(propyl acrylate); and ethylene-propylene-diene rubbers (EPDM), and hydrogenated rubbers. Of these, diene rubbers and silicone rubber are preferable.

Specific examples of the thermosetting plastic include thermosetting resins such as phenol resin, melamine resin, urea resin, polyurethane, epoxy resin and isocyanate resin. Of these, epoxy resin is preferable.

In specific examples, the metallic material is appropriately selected from among mixtures, alloys and alloys of metals such as aluminum, zinc and copper.

Use may also be made of base paper (uncoated paper), and coated paper such as high-quality paper, art paper, coat paper, cast-coated paper, baryta paper, wall paper, backing paper, synthetic resin, emulsion-impregnated paper, synthetic rubber latex-impregnated paper, paper having synthetic resin internally attached thereto, paper board, cellulose fiber paper, cellulose ester, acetyl cellulose, cellulose diacetate, cellulose triacetate, cellulose propionate, cellulose butyrate, cellulose acetate, cellulose nitrate, polyolefin-coated paper (in particular paper coated on both sides with polyethylene). Synthetic paper (e.g., polyolefin synthetic paper and polystyrene synthetic paper) and cloth may also be used.

The substrate may contain various additives as long as they will not compromise the intended effects of the invention. Exemplary additives include inorganic particles and other materials for use in the filler (e.g., glass fiber, silica particles, alumina, clay, talc, aluminum hydroxide, calcium carbonate, mica, wollastonite), silane compounds (e.g., silane coupling agent and silane adhesive), organic fillers (e.g., cured epoxy resin, crosslinked benzoguanamine resin, crosslinked acrylic polymer), plasticizers, surfactants, viscosity modifiers, colorants, curing agents, impact strength modifiers, adhesion promoters, antioxidants and UV absorbers.

Taking into account the application to semiconductor packages and various electrical circuit boards, the substrate preferably has a surface roughness Rz as measured by the ten-point means roughness method according to JIS B 0601 (1994) of up to 500 nm, more preferably up to 100 nm, even more preferably up to 50 nm and most preferably up to 20 nm. The lower limit is not particularly limited and is preferably about 5 nm and more preferably 0.

The substrate may have metal interconnects on one side or both sides thereof. The metal interconnects may be formed as a pattern on the surface of the substrate or be formed on the whole surface of the substrate. Typical examples thereof include one formed by the subtractive process using etching treatment and one formed by the semi-additive process using electrolytic plating. The metal interconnects used may be formed by any of these processes.

Exemplary materials making up the metal interconnects include copper, silver, tin, palladium, gold, nickel, chromium, tungsten, indium, zinc and gallium.

Use is made of substrates having such metal interconnects, as exemplified by a copper-clad laminate (CCL) in which the substrate is clad with copper on one side or on both sides, and a copper-clad laminate whose copper film(s) is(are) patterned. These may be flexible substrates or rigid substrates.

The laminate of the invention may be applied to semiconductor packages and various electrical circuit boards. When the laminate is used in such applications, a substrate having a layer made of an insulating resin (insulating resin layer) formed on its surface is preferably used.

Any known material may be used as the insulating resin.

(Adhesion Promoting Layer)

The adhesion promoting layer is a layer which may be optionally formed on the surface of the substrate and serves to assist the adhesion between the substrate and the layer to be plated which will be described layer. The adhesion promoting layer preferably forms a chemical bond with the polymer upon the application of energy to the polymer (through, for example, exposure to light). The adhesion promoting layer may contain the polymerization initiator.

The thickness of the adhesion promoting layer needs to be appropriately selected based on the surface smoothness of the substrate and the adhesion promoting layer generally has a thickness of preferably 0.01 to 100 μm, more preferably 0.05 to 20 μm and most preferably 0.05 to 10 μm.

The adhesion promoting layer preferably has a surface roughness Rz as measured by the ten-point mean roughness method according to JIS B 0601 (1994) of up to 3 μm and more preferably up to 1 μm in order to improve the physical properties of the metal film to be formed.

The material of the adhesion promoting layer is not particularly limited and a resin having good adhesion to the substrate is preferable. In cases where the substrate is formed of an electrical insulating resin, the thermophysical properties such as the glass transition point, modulus of elasticity and coefficient of linear expansion of the resin used are preferably close to those of the resin of the substrate. More specifically, it is preferred to use, for example, the same type of insulating resin as that making up the substrate in terms of the adhesion.

In the invention, the insulating resin for use in the adhesion promoting layer refers to a resin having sufficient insulating properties to enable the use in known insulating films, and may be applied to the invention even if it is not a complete insulator as long as it has the insulating properties suitable to the purpose.

Specific examples of the insulating resin include a thermosetting resin, a thermoplastic resin and a mixture thereof. Examples of the thermosetting resin include epoxy resin, phenol resin, polyimide resin, polyester resin, bismaleimide resin, polyolefin resin, and isocyanate resin. Examples of the thermoplastic resin include phenoxy resin, polyethersulfone, polysulfone, polyphenylene sulfone, polyphenylene sulfide, polyphenyl ether, polyetherimide and ABS resin.

The thermoplastic resins and thermosetting resins may be used alone or in combination of two or more.

A cyano group-containing resin may be used and more specifically ABS resin and a polymer containing a unit having a cyano group on the side chain as described in paragraphs [0039] to [0063] of JP 2010-84196 A may also be used.

It is preferable to use epoxy resin and ABS resin for the substrate and NBR rubber and SBR rubber polymer for the adhesion promoting layer because the adhesion promoting layer can reduce the stress applied to the substrate or the layer to be plated during heating.

The method of forming the adhesion promoting layer is not particularly limited and examples thereof include a method which involves laminating the resin used on the substrate, a method which involves dissolving necessary ingredients in a soluble solvent, applying the solution to the substrate surface by coating or other process and drying the applied solution.

The heating temperature and time in the coating process can be selected under such a condition that the applied solvent may be sufficiently dried but it is preferable to select the heating conditions including a heating temperature of up to 200° C. and a time of up to 60 minutes, and more preferably a heating temperature of 40 to 100° C. and a time of up to 20 minutes in terms of the manufacturability. As for the solvents used, optimal solvents (e.g., cyclohexanone and methyl ethyl ketone) are appropriately selected according to the resin used.

(Procedure of Step (1))

The method used to contact the above-described composition for forming the layer to be plated with the upper surface of the substrate (or the adhesion promoting layer) is not particularly limited and exemplary methods include a method which involves directly laminating the composition for forming the layer to be plated onto the substrate and a method which involves applying the composition onto the substrate when the composition for forming the layer to be plated is in the state of a liquid containing a solvent. The method which involves applying the composition onto the substrate is preferable because the thickness of the resulting layer to be plated is easily controlled.

The coating process is not particularly limited and specific examples thereof include known processes such as a coating process using a double roll coater, a slit coater, an air knife coater, a wire bar coater, a slide hopper, a spray coater, a blade coater, a doctor coater, a squeeze coater, a reverse roll coater, a transfer roll coater, an extrusion coater, a curtain coater, a die coater or a gravure roll, an extrusion coating process, and a roll coating process.

The embodiment in which the composition for forming the layer to be plated is applied onto the substrate (or the adhesion promoting layer) and dried and the solvent contained is removed to form the polymer-containing composition layer is preferable in terms of the ease of handling and the manufacturing efficiency.

In cases where the composition for forming the layer to be plated is contacted with the substrate, the coating weight in terms of solid content is preferably from 0.1 g/m² to 10 g/m² and most preferably from 0.5 g/m² to 5 g/m² in terms of the establishment of sufficient interaction with the electroless plating catalyst or its precursor.

Upon formation of the layer to be plated in this step, the substrate may be left to stand at 20 to 40° C. for 0.5 to 2 hours between the application and the drying to remove the remaining solvent.

(Application of Energy)

The method of applying energy to the composition for forming the layer to be plated on the substrate is not particularly limited and use may be made of known methods including, for example, light (e.g. ultraviolet light, visible light, X-rays), plasmas (e.g., oxygen, nitrogen, carbon dioxide, argon), heat, electricity, moisture curing, and chemical curing (e.g., chemically decomposing the surface, for example, with an acidic solution such as potassium permanganate solution).

The atmosphere under which energy is applied is not particularly limited and the energy may be applied under the atmosphere purged with an inert gas such as nitrogen, helium or carbon dioxide and having an oxygen concentration controlled to 600 ppm or less and preferably 400 ppm or less.

In the exposure to light, use is made of, for example, exposure to light using a low-pressure mercury vapor lamp, a medium-pressure mercury vapor lamp, a high-pressure mercury vapor lamp, a metal halide lamp, deep-UV light, a xenon lamp, a chemical lamp, a carbon arc lamp and visible light; scanning exposure with an infrared laser; high-illumination flash exposure with a xenon discharge lamp; and exposure with an infrared lamp. There is also an ozoneless type which generates less ozone. Other examples of the radiation include electron rays, X-rays, ion beams and far infrared rays. In addition, g-line, i-line and a high density energy beam (laser beam) may also be used. Of these, it is preferable to expose at an exposure wavelength of 250 nm to 450 nm.

The exposure energy is in a range of about 10 to about 8,000 mJ and preferably 100 to 3,000 mJ.

In the case of thermal curing, common devices such as a heating roller, a laminator, a hot stamping machine, a hot plate, a thermal head, a laser, an air dryer, an oven, a hot plate, an infrared dryer, and a heating drum may be used.

Laser beams from lasers including ion gas lasers using gases such as argon and krypton; metal vapor lasers using metals such as copper, gold and cadmium; solid-state lasers using solids such as ruby and YAG; and semiconductor lasers emitting gallium arsenide or the like in the infrared region at 750 to 870 nm may be used. However, semiconductor lasers are actually effective because of their small size, low cost, stability, reliability, durability and ease of modulation. A system using a laser may contain a material strongly absorbing laser beams.

These methods may be used alone or in combination. Any known method including a method which involves generating active species using light and then promoting through heating may be used without particular limitation.

The thickness of the resulting layer to be plated is not particularly limited and is preferably from 0.01 to 10 μm and more preferably from 0.05 μm to 5 μm in terms of the adhesion of the metal film to the substrate.

The film thickness in terms of dry weight is preferably from 0.05 to 20 g/m² and most preferably from 0.1 to 6 g/m².

In addition, the surface roughness (Ra) of the layer to be plated is preferably from 0.01 to 0.3 μm and more preferably from 0.02 to 0.15 μm in terms of the interconnect geometry and the adhesion strength. The surface roughness (Ra) was measured by non-contact interferometry according to JIS B 0601 (revised on Jan. 20, 2001) using SURFCOM 3000A (manufactured by Tokyo Seimitsu Co., Ltd.).

The content of the polymer in the layer to be plated is preferably from 2 wt % to 100 wt % and more preferably from 10 wt % to 100 wt % with respect to the total amount of the layer to be plated.

Upon application of energy, the energy may be applied in a pattern shape and then areas where the energy is not applied may be removed by any known developing treatment to form a patterned layer to be plated.

<Catalyst Applying Step>

In the catalyst applying step, the electroless plating catalyst or its precursor is applied to the layer to be plated which was obtained in the layer forming step.

In this step, the sulfonate group derived from the compound represented by formula (1) and the polymer-derived interactive group in the layer to be plated have their own functions according to which the electroless plating catalyst or its precursor having been applied thereto is adhered (adsorbed). More specifically, the electroless plating catalyst or its precursor is applied to the interior and the surface of the layer to be plated.

The electroless plating catalyst and its precursor for use in this step are first described in detail and the operation procedure is then described.

(Electroless Plating Catalyst)

Any electroless plating catalyst may be used in this step as long as it serves as the active nucleus during the electroless plating. More specifically, a metal which is capable of catalyzing the autocatalytic reduction reaction and which is known as a metal capable of electroless plating with lower ionization tendency than Ni may be used. Specific examples thereof include Pd, Ag, Cu, Ni, Al, Fe and Co. Of these, Ag and Pd are particularly preferable in terms of high catalytic activity.

The electroless plating catalyst may be used as a metallic colloid. In general, the metallic colloid can be prepared by reducing metal ions in a solution containing a charged surfactant or a charged protective agent. The charge of the metallic colloid can be adjusted by the surfactant or the protective agent used herein.

(Electroless Plating Catalyst Precursor)

The electroless plating catalyst precursor can be used in this step without any particular limitation as long as it may serve as the electroless plating catalyst through a chemical reaction. Metal ions of the metals illustrated above for the electroless plating catalyst are mainly used. The metal ions which are the electroless plating catalyst precursors are turned through the reduction reaction into zero-valent metals as the electroless plating catalysts. After the metal ion as the electroless plating catalyst precursor is applied to the layer to be plated, the metal ion may be separately turned into a zero-valent metal as the electroless plating catalyst through the reduction reaction before being immersed in the electroless plating bath. Alternatively, the metal ion may be immersed as the electroless plating catalyst precursor into the electroless plating bath and turned into a metal (electroless plating catalyst) by the action of the reducing agent in the electroless plating bath.

A metal salt is preferably used to apply the metal ion as the electroless plating catalyst precursor to the layer to be plated. The metal salt used is not particularly limited as long as it dissolves in a suitable solvent to dissociate into a metal ion and a base (anion). Examples thereof include M(NO₃)ₙ, MClₙ, M_{2/n}(SO₄) and M_{3/n}(PO₄) (M represents an n-valent metal atom). The metal ion resulting from the dissociation of the metal salt may be advantageously used. Specific examples of the metal ion include Ag ion, Cu ion, Al ion, Ni ion, Co ion, Fe ion, and Pd ion. Among these, ions capable of multidentate coordination are preferred. Ag ion and Pd ion are particularly preferred in terms of the number of types of functional group capable of coordination and the catalytic activity.

A preferable example of the electroless plating catalyst or its precursor that may be used in the invention includes a palladium compound. The palladium compound functions as the plating catalyst (palladium) or its precursor (palladium ion) which serves as an active nucleus during the plating treatment to deposit the metal. The palladium compound is not particularly limited as long as it contains palladium and serves as the nucleus during the plating treatment. Examples thereof include a palladium (II) salt, a palladium (0) complex and a palladium colloid.

Other preferable examples of the electroless plating catalyst or its precursor include silver and silver ion.

In the case of using silver ion, silver ion obtained by the dissociation of the silver compounds illustrated below may be used with advantage. Specific examples of the silver compounds include silver nitrate, silver acetate, silver sulfate, silver carbonate, silver cyanide, silver thiocyanate, silver chloride, silver bromide, silver chromate, silver chloranilate, silver salicylate, silver diethyldithiocarbamate, silver diethyldithiocarbamate and silver p-toluenesulfonate. Of these, silver nitrate is preferable in terms of the water solubility.

A method of applying a metal as the electroless plating catalyst or a metal salt as the electroless plating catalyst precursor to the layer to be plated involves preparing a dispersion of the metal in a suitable dispersion medium or a solution of the metal salt dissociated into a metal ion by dissolved in a suitable solvent, and applying the dispersion or the solution to the layer to be plated or immersing the substrate having the layer to be plated formed thereon in the dispersion or the solution.

By contacting the electroless plating catalyst or its precursor with the layer to be plated as described above, the electroless plating catalyst or its precursor can be adsorbed onto the sulfonate group or the interactive group included in the layer to be plated by means of the interaction based on the intermolecular force such as van der Waals force or the interaction based on the coordination bond using lone-pair electrons.

In order to sufficiently adsorb the electroless plating catalyst or its precursor, the metal concentration or the metal ion concentration in the dispersion or the solution is preferably in a range of 0.001 to 50 wt % and more preferably 0.005 to 30 wt %.

The contact time is preferably from about 30 seconds to about 24 hours and more preferably from about 1 minute to about 1 hour.

(Organic Solvent and Water)

As described above, the above-described electroless plating catalyst or its precursor is preferably applied to the layer to be plated in the form of a dispersion or a solution (plating catalyst solution).

An organic solvent or water is used for the dispersion or the solution. The organic solvent contained contributes to improving the permeability of the electroless plating catalyst or its precursor through the layer to be plated, whereby the electroless plating catalyst or its precursor can be efficiently adsorbed onto the sulfonate group or the interactive group.

Water may be used in the dispersion or the solution. The water preferably contains no impurities and in this regard, it is preferable to use RO water, deionized water, distilled water or purified water, and most preferably deionized water or distilled water.

The organic solvent that may be used to prepare the dispersion or the solution is not particularly limited as long as the solvent can permeate the layer to be plated. Specific examples of the solvent that may be used include acetone, methyl acetoacetate, ethyl acetoacetate, ethylene glycol diacetate, cyclohexanone, acetylacetone, acetophenone, 2-(1-cyclohexenyl)cyclohexanone, propylene glycol diacetate, triacetin, diethylene glycol diacetate, dioxane, N-methylpyrrolidone, dimethyl carbonate and dimethyl cellosolve.

In particular, in terms of the compatibility with the electroless plating catalyst or its precursor and the permeability through the layer to be plated, water-soluble organic solvents are preferable, and acetone, dimethyl carbonate, dimethyl cellosolve, triethylene glycol monomethyl ether, diethylene glycol dimethyl ether and diethylene glycol diethyl ether are preferable.

In addition, the dispersion and the solution may contain other additives according to the intended purpose. Exemplary other additives include a swelling agent and a surfactant.

The amount of adsorption of the electroless plating catalyst or its precursor onto the layer to be plated is different depending on the type of the plating bath used, the type of the catalyst metal, the type of the interactive group in the layer to be plated, the usage and the like, but is preferably from 5 to 1,000 mg/m², more preferably from 10 to 800 mg/m² and most preferably from 20 to 600 mg/m² in terms of the plating deposition properties.

<Plating Step>

The plating step is a step which includes subjecting the layer to be plated which was obtained in the catalyst applying step and onto which the electroless plating catalyst or its precursor is adsorbed, to electroless plating to form the metal film on the plated layer.

More specifically, in this step, a metal film 14 is formed on the plated layer 12 to obtain a laminate 16 as shown in FIG. 1C. In a more preferred embodiment, electroless plating is further followed by electrolytic plating in order to obtain the metal film 16 with a desired thickness.

The plating treatment performed in this step is described below.

(Electroless Plating)

Electroless plating refers to an operation in which a metal is deposited by a chemical reaction using a solution containing metal ions to be deposited by plating.

Electroless plating in this step is performed by, for example, washing the substrate to which the electroless plating catalyst has been applied with water to remove excess electroless plating catalyst (metal), and then immersing the substrate in an electroless plating bath. Any known electroless plating bath may be used for electroless plating.

In cases where the substrate to which the electroless plating catalyst precursor has been applied is immersed in the electroless plating bath with the electroless plating catalyst precursor adsorbed onto or impregnated into the layer to be plated, the substrate is washed with water to remove excess precursor (metal salt or the like) prior to the immersion in the electroless plating bath. In this case, reduction of the plating catalyst precursor and the subsequent electroless plating are performed in the electroless plating bath. Any known electroless plating bath may be used as above for the electroless plating bath used herein.

Instead of the embodiment using the above-described electroless plating solution, it is also possible to reduce the electroless plating catalyst precursor as a separate step preceding the electroless plating by preparing a catalyst activating solution (reducing solution). The catalyst activating solution is a solution containing a reducing agent which can reduce the electroless plating catalyst precursor (mainly a metal ion) to a zero-valent metal, and the concentration of the reducing agent is preferably from 0.1 wt % to 50 wt % and more preferably from 1 wt % to 30 wt % with respect to the total solution. Examples of the reducing agent that may be used include boron-based reducing agents such as sodium borohydride and dimethylamine borane, and other reducing agents such as formaldehyde and hypophosphorous acid.

In the immersion, the layer to be plated is preferably immersed in the plating bath as it is stirred or shaken in order to keep the electroless plating catalyst or its precursor in the vicinity of the surface of the layer to be plated with which the electroless plating catalyst or its precursor is contacted at a constant concentration.

In addition to the solvent (e.g., water), the general composition of the electroless plating bath mainly includes 1. a metal ion for plating, 2. a reducing agent, and 3. an additive enhancing the stability of the metal ion (stabilizer). In addition to these ingredients, this plating bath may contain known additives such as a stabilizer for the plating bath.

The organic solvent that may be used in the plating bath is to be soluble in water and in view of this, ketones such as acetone, and alcohols such as methanol, ethanol and isopropanol are preferably used.

Copper, tin, lead, nickel, gold, silver, palladium and rhodium are known metals that may be used in the electroless plating bath. Of these, copper and gold are particularly preferred in terms of electrical conductivity. The most appropriate reducing agent and additives for the metal used are selected.

The thickness of the metal film thus formed by electroless plating can be controlled by adjusting the metal ion concentration in the plating bath, the immersion time in the plating bath, or the temperature of the plating bath. The metal film preferably has a thickness of at least 0.1 μm and more preferably 0.2 μm to 2 μm in terms of electrical conductivity.

However, in cases where the metal film formed by electroless plating is used as the electrical conduction layer to perform electrolytic plating to be described below, it is preferable for a film with a thickness of at least 0.1 μm to be formed uniformly.

The immersion time in the plating bath is preferably from about 1 minute to about 6 hours and more preferably from about 1 minute to about 3 hours.

The cross-section of the metal film obtained as above by electroless plating is observed by a scanning electron microscope (SEM) and it is confirmed that the plating catalyst and fine particles of the metal used for plating are dispersed in the plated layer at high densities and the metal used for plating is further deposited on the plated layer. The interface between the plated layer and the metal film is in a hybrid state including a resin complex and fine particles and therefore good adhesion is obtained even if the interface between the plated layer and the metal film is smooth.

(Electrolytic Plating (Electroplating))

In this step, the electroless plating treatment may be optionally followed by electrolytic plating. In this way, a new metal film with a desired thickness can be easily formed on the film formed by electroless plating and having good adhesion to the substrate. A metal film with a thickness suitable to the intended purpose can be formed by electrolytic plating following electroless plating and therefore the metal film can be advantageously used in various applications.

Any conventionally known method may be used for electrolytic plating. Examples of the metal that may be used in electrolytic plating include copper, chromium, lead, nickel, gold, silver, tin, and zinc. In terms of electrical conductivity, copper, gold and silver are preferred and copper is more preferred.

The thickness of the metal film obtained by electrolytic plating can be controlled by adjusting the concentration of the metal contained in the plating bath, current density or the like.

When used in general electrical interconnects, the metal film preferably has a thickness of at least 0.5 μm and more preferably 1 to 30 μm in terms of electrical conductivity.

The thickness of the electrical interconnects is reduced with decreasing line width of the electrical interconnects or with miniaturizing it in order to maintain the aspect ratio. Therefore, the thickness of the metal film formed by electrolytic plating is not limited to the above-defined range but may be arbitrarily set.

<Laminate>

This step enables the laminate 16 including the substrate 10, the plated layer 12 and the metal film 14 formed in this order (laminate with the metal film) to be obtained as shown in FIG. 1C.

The resulting laminate 16 can be used in various fields and may be used, for example, in a wide variety of industrial fields including electricity/electronics/communications, agriculture/forestry and fishery, mining, construction, food, textile, apparel, medicine, coal, petroleum, rubber, leather, automobile, precision equipment, lumber, building materials, civil engineering, furniture, printing and musical instrument industries.

More specifically, the laminate may be used in applications including office equipment and office automation equipment such as printers, personal computers, word processors, keyboards, PDAs (small information terminals), telephones, copiers, facsimile apparatuses, ECRs (electronic cash registers), calculators, electronic organizers, cards, holders, and stationery; household electrical appliances such as washing machines, refrigerators, cleaners, microwave ovens, lighting apparatuses, game machines, clothes irons, and Japanese-style warming devices; audio-visual equipment such as TVs, VTRs, video cameras, radio-cassette recorders, tape recorders, minidisc players, CD players, speakers, and liquid crystal displays; electrical and electronic components such as connectors, relays, capacitors, switches, printed circuit boards, coil bobbins, semiconductor encapsulation materials, LED encapsulation materials, electric wires, cables, transformers, deflection yokes, distribution boards, semiconductor chips, various electrical circuit boards, FPCs, COFs, TABs, two-layer CCL (copper clad laminate) materials, electrical interconnection materials, multilayer circuit boards, mother boards, antennas, electromagnetic shielding films, and watches; and other communication equipment.

In particular, since the smoothness at the interface between the metal film and the plated layer is improved, the laminate can be applied to various applications including accessories (glass frames, car accessories, jewelry goods, gaming consoles, western tableware, faucet brackets, and lighting apparatuses) and applications in which high-frequency transmission is to be ensured (e.g., for circuit boards, for printed circuit boards).

<Optional Step: Patterning Step>

The laminate obtained as above may be optionally subjected to the step which includes pattern-etching the metal film to form a patterned metal film.

More specifically, in this step, unnecessary portions of the metal film 14 are removed to form a patterned metal film 18 on the plated layer 12, as shown in FIG. 1D. In this step, unnecessary portions of the metal film formed on the whole surface of the substrate can be removed by etching to form a desired patterned metal film.

Any process may be used to form the pattern and more specifically, use is made of commonly known processes including the subtractive process which involves forming a patterned mask on a metal film, etching areas where no mask is formed, and removing the mask to form a patterned metal film, and the semi-additive process which involves forming a patterned mask on a metal film, plating so as to form a metal film in areas where no mask is formed, removing the mask and etching to form a patterned metal film.

More specifically, the subtractive process is a process which involves forming a resist layer on the formed metal film, subjecting the resist layer to pattern-exposure and development to form the same pattern as in the metal film pattern portion and removing the metal film with an etching solution while using the resist pattern as the mask to form a patterned metal film.

Any material may be used for the resist as exemplified by negative type, positive type, liquid type and film type. Etching techniques commonly used in the manufacture of printed circuit boards may be used as exemplified by wet etching and dry etching, and a suitable technique can be selected. Wet etching is preferred because the device is simple to handle. For example, an aqueous solution of cupric chloride or ferric chloride may be used as the etching solution.

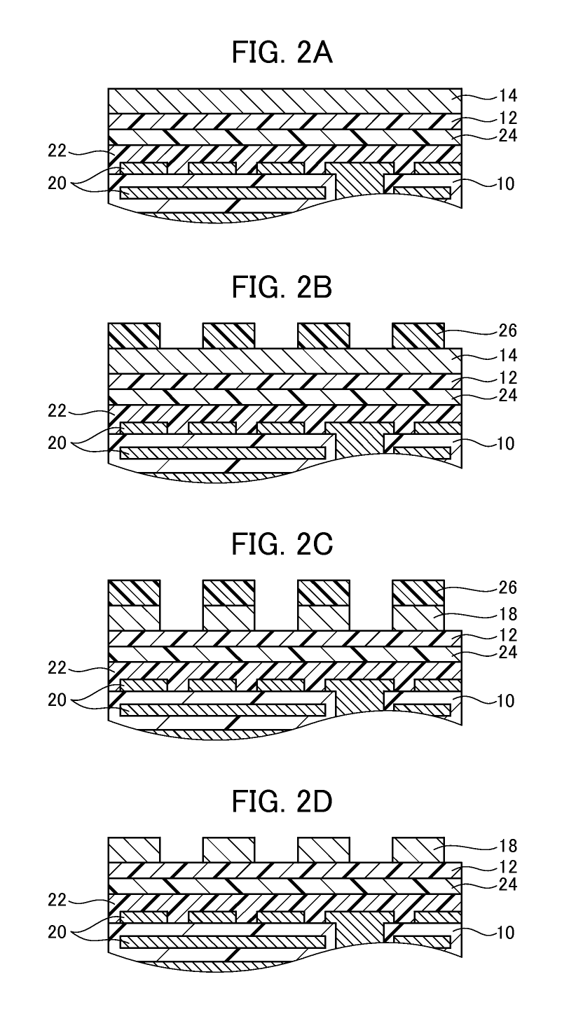

An example of the etching step using the subtractive process is more specifically shown in FIG. 2.

The plating step in the above-described step (4) is first performed to prepare a laminate as shown in FIG. 2A including a substrate 10, an insulating resin layer 22, an adhesion promoting layer 24, a plated layer 12 and a metal film 14. In FIG. 2A, the substrate 10 has metal interconnects 20 formed on the surface and in the interior thereof. The insulating resin layer 22, the adhesion promoting layer 24 and the metal interconnects 20 are optionally added constituent members. In FIG. 2A, the metal film 14 is formed on one side of the substrate 10 but may be formed on both sides thereof.

Next, a patterned mask 26 is provided on the metal film 14 as shown in FIG. 2B.

Then, the metal film 14 in the areas where no mask is provided is removed by etching (e.g. dry etching or wet etching) to obtain a patterned metal film 18 as shown in FIG. 2C. Finally, the mask 26 is removed to obtain a laminate of the invention (see FIG. 2D).

More specifically, the semi-additive process is a process which involves forming a resist layer on the formed metal film, subjecting the resist layer to pattern-exposure and development to form the same pattern as in non-metal film pattern portion, performing electrolytic plating while using the resist pattern as the mask, removing the resist pattern and performing quick etching to remove the metal film in a pattern shape to form a patterned metal film.

The same materials as used in the subtractive process may be used for the resist and etching solution. The foregoing process may be used for electrolytic plating.

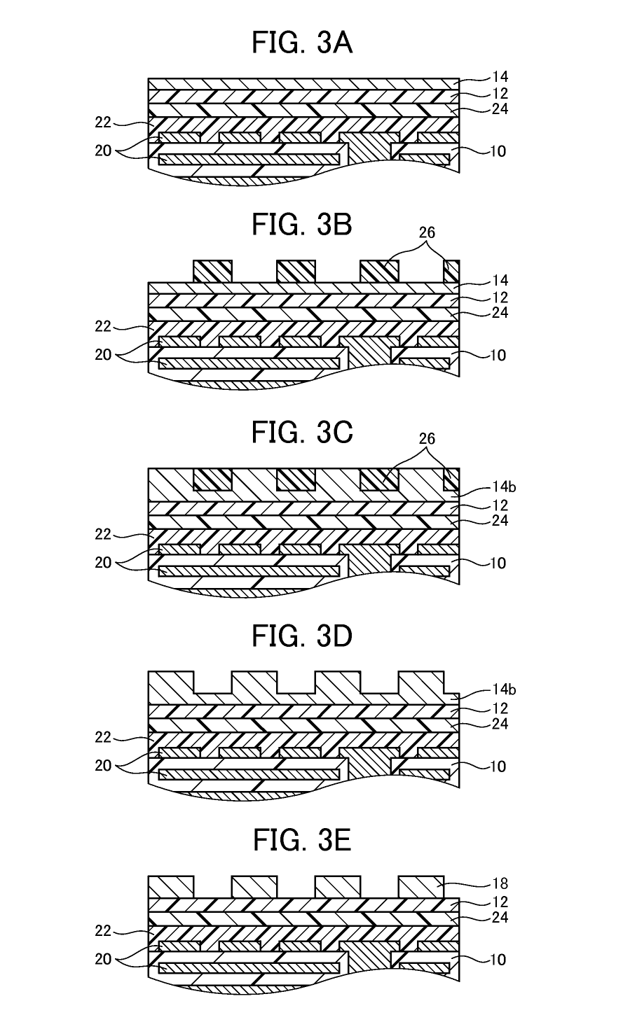

An example of the etching step using the semi-additive process is more specifically shown in FIG. 3.

A laminate as shown in FIG. 3A including a substrate 10, an insulating resin layer 22, an adhesion promoting layer 24, a plated layer 12 and a metal film 14 is prepared.

Next, a patterned mask 26 is provided on the metal film 14 as shown in FIG. 3B.

Next, electrolytic plating is performed to obtain a metal film 14b having a metal film formed in the areas where the mask 26 is not provided, as shown in FIG. 3C.

Then, the mask 26 is removed as shown in FIG. 3D and etching treatment (e.g., dry etching or wet etching) is performed to obtain a laminate including a patterned metal film 18 as shown in FIG. 3E.

The plated layer may be removed by any known means (e.g., dry etching) simultaneously with the removal of the metal film.

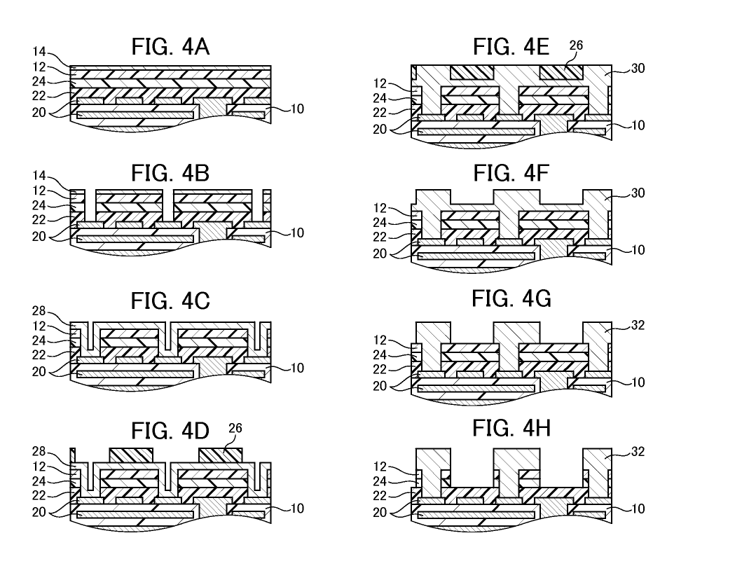

In addition, in cases where the etching step is performed by the semi-additive process, this step may be performed to obtain a multilayer circuit board as shown in FIG. 4.

A laminate as shown in FIG. 4A including a substrate 10, an insulating resin layer 22, an adhesion promoting layer 24, a plated layer 12 and a metal film 14 is first prepared.

Next, via holes which penetrate through the metal film 14, the plated layer 12, the adhesion promoting layer 24 and the insulating resin layer 22 to reach metal interconnects 20 are formed by laser machining or drilling, as shown in FIG. 4B. Then, smear is optionally removed.

In addition, the plating catalyst is applied to the wall surfaces of the formed via holes and electroless plating and/or electrolytic plating is performed to obtain, as shown in FIG. 4C, a metal film 28 which is in contact with the metal interconnects 20.

A predetermined patterned mask 26 is formed on the metal film 28 as shown in FIG. 4D and electrolytic plating is performed to obtain a metal film 30 (see FIG. 4E).

Then, the mask 26 is removed (see FIG. 4F) and thereafter etching (e.g., dry etching or wet etching) is performed to obtain a patterned metal film 32 (see FIG. 4G). Then, the plated layer 12 and the adhesion promoting layer 24 may be optionally removed by plasma treatment or the like (see FIG. 4H).

### EXAMPLES

The invention is described below in further detail by way of examples. However, the invention should not be construed as being limited to the following examples.

### Synthesis Example 1

### Polymer 1

Into a three-necked flask with a volume of 2 L were introduced 1 L of ethyl acetate and 159 g of 2-aminoethanol and the mixture was cooled in an ice bath. To the mixture was added dropwise 150 g of 2-bromoisobutyryl bromide while adjusting the internal temperature to 20° C. or less. Then, the internal temperature was raised to room temperature (25° C.) and the reaction was allowed to take place for 2 hours. After the end of the reaction, 300 mL of distilled water was added to quench the reaction. Then, the ethyl acetate layer was washed with 300 mL of distilled water four times and dried over magnesium sulfate. Ethyl acetate was further distilled off to yield 80 g of Material A.

Next, 47.4 g of Material A, 22 g of pyridine and 150 mL of ethyl acetate were introduced into a three-necked flask with a volume of 500 mL and the mixture was cooled in an ice bath. To the mixture was added dropwise 25 g of acrylyl chloride while adjusting the internal temperature to 20° C. or less. Then, the temperature was raised to room temperature and the reaction was allowed to take place for 3 hours. After the end of the reaction, 300 mL of distilled water was added to quench the reaction. Then, the ethyl acetate layer was washed with 300 mL of distilled water four times and dried over magnesium sulfate. Ethyl acetate was further distilled off. Then, the distillate was purified by column chromatography to obtain 20 g of Monomer M1 shown below.

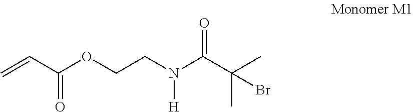

Into a three-necked flask with a volume of 500 mL was introduced 8 g of N,N-dimethylacetamide, which was heated to 65° C. in a nitrogen stream. A solution of 14.3 g of Monomer M1, 3.0 g of acrylonitrile (Tokyo Chemical Industry Co., Ltd.), 6.5 g of acrylic acid (Tokyo Chemical Industry Co., Ltd.), and 0.4 g of V-65 (Wako Pure Chemical Industries, Ltd.) in 8 g of N,N-dimethylacetamide was added dropwise over 4 hours.

After the completion of the dropwise addition, the reaction solution was further stirred for 3 hours. Then, 41 g of N,N-dimethylacetamide was added and the reaction solution was cooled to room temperature. To the reaction solution were added 0.09 g of 4-hydroxy-TEMPO (Tokyo Chemical Industry Co., Ltd.) and 54.8 g of DBU and the mixture was reacted at room temperature for 12 hours. Then, to the reaction solution was added 54 g of a 70 wt % aqueous solution of methanesulfonic acid. After the end of the reaction, the solid was collected by reprecipitation with water to obtain 12 g of Polymer 1.

The resulting Polymer 1 was identified with an infrared meter (HORIBA, Ltd.). The polymer was dissolved in acetone and KBr crystals were used to perform the measurement. As a result of the IR measurement, a peak was observed at around 2240 cm⁻¹ and it was shown that acrylonitrile which is a nitrile unit was introduced into the polymer. The acid number measurement showed that acrylic acid which is a carboxylic acid unit was introduced into the polymer. The polymer was also dissolved in deuterated DMSO (dimethyl sulfoxide) and measured by NMR (AV-300) (Bruker, 300 MHz). A broad peak corresponding to the nitrile group-containing unit was observed at 2.5-0.7 ppm (5H), broad peaks corresponding to the polymerizable group-containing unit were observed at 7.8-8.1 ppm (1H), 5.8-5.6 ppm (1H), 5.4-5.2 ppm (1H), 4.2-3.9 ppm (2H), 3.3-3.5 ppm (2H) and 2.5-0.7 ppm (6H), and a broad peak corresponding to the carboxylic acid-containing unit was observed at 2.5-0.7 ppm (3H), and it was revealed that the ratio between the polymerizable group-containing unit:nitrile group-containing unit:carboxylic acid group unit was 30:30:40 (mol %).

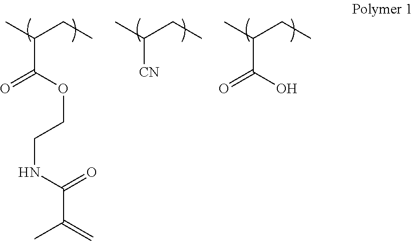

### Synthesis Example 2

### Polymer 2

Into a three-necked flask with a volume of 500 mL was introduced 20 g of N,N-dimethylacetamide, which was heated to 65° C. in a nitrogen stream. A solution of 20.7 g of Monomer M2, 20.5 g of 2-cyanoethyl acrylate (Tokyo Chemical Industry Co., Ltd.), 14.4 g of acrylic acid (Tokyo Chemical Industry Co., Ltd.), and 1.0 g of V-65 (Wako Pure Chemical Industries, Ltd.) in 20 g of N,N-dimethylacetamide was added dropwise over 4 hours. After the completion of the dropwise addition, the mixture was further stirred for 3 hours. Then, 91 g of N,N-dimethylacetamide was added and the reaction solution was cooled to room temperature.

To the reaction solution were added 0.17 g of 4-hydroxy-TEMPO (Tokyo Chemical Industry Co., Ltd.) and 75.9 g of triethylamine and the mixture was reacted at room temperature for 4 hours. Then, to the reaction solution was added 112 g of a 70 wt % aqueous solution of methanesulfonic acid. After the end of the reaction, the solid was collected by reprecipitation with water to obtain 25 g of Polymer 2.

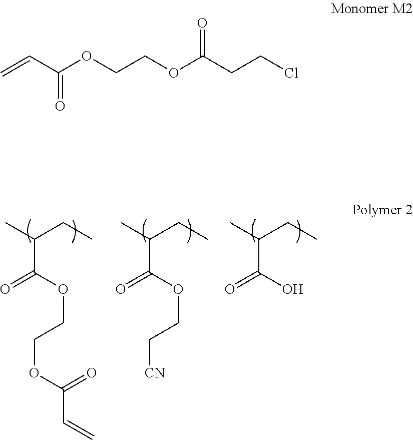

### Synthesis Example 3

### Polymer 3

Into a three-necked flask with a volume of 500 mL were introduced 200 g of N,N-dimethylacetamide, 30 g of polyacrylic acid (Wako Pure Chemical Industries, Ltd., molecular weight: 25,000), 2.4 g of tetraethylammonium benzylchloride, 25 mg of di-tert-pentylhydroquinone, and 27 g of CYCLOMER A (Daicel Chemical Industries, Ltd.), and the mixture was reacted in a nitrogen stream at 100° C. for 5 hours. Then, the reaction solution was reprecipitated and the solid was collected by filtration to obtain 28 g of Polymer 3.

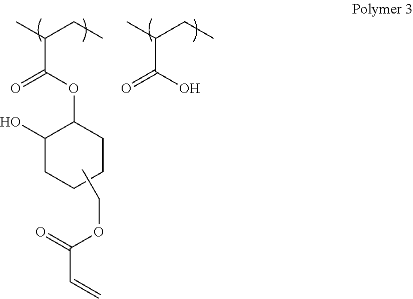

### Synthesis Example 4

### Polymer 4

Into a three-necked flask with a volume of 500 mL was introduced 24 g of N,N-dimethylacetamide, which was heated to 60° C. in a nitrogen stream. A solution of 25.4 g of Monomer M1, 26 g of 2-hydroxyethyl acrylate (Tokyo Chemical Industry Co., Ltd.), and 0.57 g of V-601 (Wako Pure Chemical Industries, Ltd.) in 43.6 g of N,N-dimethylacetamide was added dropwise over 6 hours.

After the completion of the dropwise addition, the reaction solution was further stirred for 3 hours. Then, 40 g of N,N-dimethylacetamide was added and the reaction solution was cooled to room temperature. To the reaction solution were added 0.15 g of 4-hydroxy-TEMPO (Tokyo Chemical Industry Co., Ltd.) and 33.2 g of DBU and the mixture was reacted at room temperature for 12 hours. Then, to the reaction solution was added 24 g of a 70 wt % aqueous solution of methanesulfonic acid. After the end of the reaction, the solid was collected by reprecipitation with water to obtain 20 g of Polymer 4.

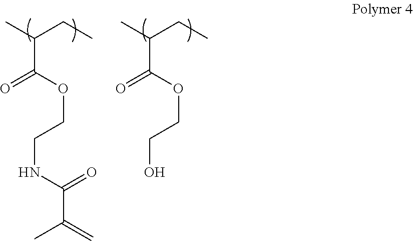

<Preparation of Composition for Forming Layer to be Plated>

Into a 100-mL beaker including a magnetic stirrer were introduced water, propylene glycol monomethyl ether, 2-acrylamide-2-methylpropanesulfonic acid, Polymer 1, hexamethylene-bis-acrylamide and IRGACURE 2959 (CIBA) according to Table 1. The solutions were prepared to obtain Compositions 1 to 5.

In Table 1, the contents of the respective ingredients (e.g., solvent, sulfone compound, polymer, polyfunctional monomer, polymerization initiator) are expressed in wt % with respect to the total amount of the composition.

TABLE 1

| | | Composition 1 | Composition 2 | Composition 3 | Composition 4 | Composition 5 |
|---|---|---|---|---|---|---|
| Solvent | Water | 46.48 | 46.44 | 46.42 | 46.4 | 46.39 |
| | Propylene glycol monomethyl ether | 46.48 | 46.44 | 46.42 | 46.4 | 46.39 |
| Compound represented | 2-Acrylamide-2- | 0 | 0.5 | 1 | 1.4 | 1.75 |
| by formula (1) | methylpropanesulfonic acid | | | | | |
| (hereinafter sulfone | | | | | | |
| compound) | | | | | | |
| Polymer | Polymer 1 | 7 | 6.5 | 6 | 5.6 | 5.25 |
| Polyfunctional monomer | Hexamethylene-bis-acrylamide | 0.04 | 0.06 | 0.08 | 0.1 | 0.11 |
| Polymerization initiator | IRGACURE2959 | 0.04 | 0.06 | 0.08 | 0.1 | 0.11 |

| | | | | | |
|---|---|---|---|---|---|
| [Weight of sulfone compound/(weight of sulfone compound + | 0.0% | 7.1% | 14.3% | 20.0% | 25.0% |
| weight of polymer)] × 100 | | | | | |

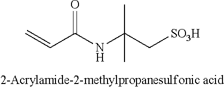

### Examples 1 to 4 and Comparative Example 1

### [Preparation of Layer to be Plated]

GX-13 (Ajinomoto Fine-Techno Co., Inc.) was vacuum laminated on a FR-4 substrate (Hitachi Chemical Co., Ltd., glass epoxy resin substrate) and the surface of the substrate was treated with a 5% sodium hydroxide solution at 60° C. for 5 minutes. The resulting substrate surface had a water contact angle of 52°.

Then, the compositions for forming the layer to be plated (Compositions 1 to 5) which were shown in Table 1 were dropped onto the surface of the substrate and applied by spin coating at 3,000 rpm for 20 seconds. Then, the substrate was exposed to UV radiation (amount of energy: 2 J; 10 mW; wavelength: 256 nm) under vacuum to cure the layer to be plated. The substrates obtained using Compositions 1 to 5 and each having the layer to be plated (layer thickness: 250 nm) were denoted by Sub 1-1 to Sub 1-5, respectively.

[Application of Catalyst and Electroless Plating]

Sub 1-1 to Sub 1-5 were immersed in a cleaner/conditioner solution ACL-009 (C. Uyemura & Co., Ltd.) at 50° C. for 5 minutes and washed twice with pure water. Then, Sub 1-1 to Sub 1-5 were immersed in a Pd catalyst applying solution MAT-2 (C. Uyemura & Co., Ltd.) at room temperature for 5 minutes and washed twice with pure water.

Next, Sub 1-1 to Sub 1-5 having undergone the above treatments were immersed in a reducing agent MAB (C. Uyemura & Co., Ltd.) at 36° C. for 5 minutes and washed twice with pure water. Then, Sub 1-1 to Sub 1-5 were immersed in an activation treatment solution MEL-3 (C. Uyemura & Co., Ltd.) at room temperature for 5 minutes and then immersed without washing in an electroless plating solution THRU-CUP PEA (C. Uyemura & Co., Ltd.) at room temperature for 30 minutes. The substrates obtained using Sub 1-1 to Sub 1-5 were denoted by ELP 1-1 to ELP 1-5, respectively.

[Electrolytic Plating]

A mixture solution containing 1,283 g of water, 135 g of copper sulfate pentahydrate, 342 g of 98% concentrated sulfuric acid, 0.25 g of 36% concentrated hydrochloric acid and 39.6 g of ET-901M (Rohm and Haas Company) was used as the electrolytic plating solution, and each of ELP 1-1 to ELP 1-5 having a holder attached thereto and a copper sheet were connected to a power supply to perform copper electroplating at 3 A/dm² for 45 minutes to thereby obtain an electrodeposited copper film (metal film) with a thickness of about 18 μm. The substrates obtained using ELP 1-1 to ELP 1-5 were denoted by EP 1-1 to EP 1-5, respectively.

<Evaluation>

### (Measurement of Peel Strength)

EP 1-1 to EP 1-5 were heated at 100° C. for 30 minutes and further heated at 180° C. for 1 hour. In each of the resulting samples, 130-mm parallel slits were made at a distance of 10 mm, a slit was made at the end with a cutter and a 10-mm portion was made upright. The end that was peeled off was clipped and its peel strength was measured by Tensilon (Shimadzu Corporation) (elongation rate: 50 mm/min). The results are shown in Table 2.

(Plating Deposition Properties)

Each of ELP 1-1 to ELP 1-5 with an area of 1 cm² was secured to an acrylic block and put in a dedicated mold. After pouring an acrylic resin Acryl One (Maruto Instrument Co., Ltd.) into the mold, the mold was exposed to light for 2 hours using an exposure apparatus ONE•LIGHT (Maruto Instrument Co., Ltd.) to cure the acrylic resin. The cured resin was washed with acetone and polished in a polishing apparatus ML-160A (Maruto Instrument Co., Ltd.) using 400 grit abrasive paper until the surface of the substrate emerged, and the substrate surface was polished by Baikaloyl.0CR (BAIKOWSK INTERNATIONAL CORPORATION) until the substrate had a mirror surface. Gold for preventing charge-up was vapor-deposited on the surface and the copper film thickness was observed by Miniscope TM-1000 (HITACHI). The values in terms of the film deposition rate per 60 minutes are shown in Table 2.

TABLE 2

| | Comparative Example 1 | Example 1 | Example 2 | Example 3 | Example 4 |
|---|---|---|---|---|---|
| Type of Composition | Composition 1 | Composition 2 | Composition 3 | Composition 4 | Composition 5 |
| Electroless plating rate | 0.37 | 1.35 | 1.46 | 1.42 | 1.44 |
| (μm/h) | | | | | |
| Peel strength | Lack of thickness of | 0.77 | 0.8 | 0.81 | 0.6 |
| (N/mm) | film formed by | | | | |
| | electroless plating | | | | |

As shown in Table 2, it was confirmed that Examples 1 to 4 which used Compositions 2 to 5 corresponding to the compositions for forming the layer to be plated according to the invention each exhibited excellent electroless plating rate and peel strength. Of these, Examples 1 to 3 in which the ratio expressed by {weight of sulfone compound/(weight of sulfone compound+weight of polymer)} was 0.20 or less exhibited particularly excellent peel strength.

On the other hand, in Comparative Example 1 using Composition 1 which did not contain the compound represented by formula (1), the electroless plating rate was also poor and a sufficient film thickness could not be obtained to hinder the measurement of the peel strength.

### Examples 5 to 9 and Comparative Example 2

Compositions 6 to 9 were prepared by using the same compositional ratio as that of Composition 3 in Table 1 but changing the types of the compound represented by formula (1), the polymer and the polyfunctional monomer. The monomers and polymers used are shown in Table 3. In the preparation of Composition 10, no polyfunctional monomer was used but solvents 1 and 2 were added in equal amounts to a weight ratio of 100 wt %.

In Table 3, the monomer used in Composition 7 does not correspond to the compound represented by formula (1).

[Table 3]

TABLE 3

| | Composition 6 | Composition 7 | Composition 8 | Composition 9 | Composition 10 |
|---|---|---|---|---|---|
| Solvent 1 | Water | Water | Water | Water | Water |
| Solvent 2 | Propylene glycol | Propylene glycol | Propylene glycol | Propylene glycol | Propylene glycol |
| | monomethyl ether | monomethyl ether | monomethyl ether | monomethyl ether | monomethyl ether |
| Monomer | Styrenesulfonic acid | N-(Hydroxymethyl) | 2-Acrylamide-2- | 2-Acrylamide-2- | 2-Acrylamide-2- |
| | | acrylamide | methylpropane- | methylpropane- | methylpropane- |
| | | | sulfonic acid | sulfonic acid | sulfonic acid |
| Polymer | Polymer 1 | Polymer 1 | Polymer 2 | Polymer 3 | Polymer 4 |
| Polyfunctional monomer | Hexamethylene-bis- | Hexamethylene-bis- | 1,4- | Methylene-bis- | None |
| | acrylamide | acrylamide | Bis(acryloyl)piperazine | acrylamide | |
| Polymerization initiator | IRGACURE2959 | IRGACURE2959 | IRGACURE2959 | IRGACURE2959 | IRGACURE2959 |

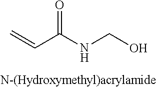

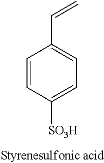

[Preparation of Layer to Be Plated], [Application of Catalyst and Electroless Plating], and [Electrolytic Plating] which were mentioned above were performed using the foregoing Compositions 6 to 10.

GX-13 was vacuum laminated on a FR-4 substrate and Composition 11 using the compounds shown in Table 4 for the adhesion promoting layer was applied to the surface of the substrate by spin coating at 1,500 rpm for 20 seconds, heated at 170° C. for 1 hour and treated with a 5% sodium hydroxide solution at 60° C. for 5 minutes. The resulting substrate surface had a water contact angle of 48°. In Table 4, values are expressed in g (gram).

Then, Composition 3 was dropped onto the surface of the substrate and applied by spin coating at 3,000 rpm for 20 seconds. Then, the substrate was exposed to UV radiation (amount of energy: 2 J; 10 mW; wavelength: 256 nm) under vacuum to cure the layer to be plated. Subsequently, [Application of Catalyst and Electroless Plating], and [Electrolytic Plating] which were mentioned above were performed. These results are shown in Table 5.

TABLE 4

| | Composition 11 | |
|---|---|---|
| Solvent | Cyclohexanone | 52 |
| Resin 1 | Liquid bisphenol F epoxy resin JER806, | 15 |
| | Mitsubishi Chemical Corporation | |
| Resin 2 | Phenoxy resin YP-50EK30, Nippon Steel | 30 |
| | Chemical Co., Ltd. | |
| Resin 3 | Novolak resin PHENOLITE LA-7052, DIC | 3 |
| Curing accelerator | 2-Ethyl-4-methylimidazole | 0.2 |

TABLE 5

| | | | Comparative | | | | |
|---|---|---|---|---|---|---|---|
| | Example 2 | Example 5 | Example 2 | Example 6 | Example 7 | Example 8 | Example 9 |
| Type of Composition | Composition 3 | Composition 6 | Composition 7 | Composition 8 | Composition 9 | Composition 10 | Composition 3 |
| Electroless plating | 1.46 | 1.13 | 0.41 | 1.41 | 1.39 | 1.32 | 1.48 |
| rate (μm/h) | | | | | | | |
| Peel strength | 0.8 | 0.7 | Lack of thickness | 0.78 | 0.73 | 0.65 | 0.92 |
| (N/mm) | | | of film formed by | | | | |
| | | | electroless plating | | | | |
| Adhesion promoting | Unformed | Unformed | Unformed | Unformed | Unformed | Unformed | Formed |
| layer | | | | | | | |

Table 5 confirmed that Example 5 which used Composition 6 containing styrenesulfonic acid exhibited excellent electroless plating rate and peel strength.

On the other hand, in Comparative Example 2 which used Composition 7 containing N-(hydroxymethyl)acrylamide which does not correspond to the compound represented by formula (1), the electroless plating rate was poor and a sufficient film thickness could not be obtained to hinder the measurement of the peel strength.

It was confirmed that Examples 6 to 8 respectively using Compositions 8 to 10 which are different in polymer type and Example 9 in which the adhesion promoting layer was added also exhibited excellent electroless plating rate and peel strength.

The comparison of Examples 1 to 3 and 6 to 8 showed that Examples 1 to 3, 6 and 7 in which the polyfunctional monomer was included exhibited particularly excellent peel strength.

### Example 10

The substrate obtained in Example 1 which had undergone copper electroplating was heat-treated at 180° C. for 1 hour and a dry resist film (Hitachi Chemical Co., Ltd.; RY3315; film thickness: 15 μm) was laminated on the surface of the substrate at 70° C. and 0.2 MPa by a vacuum laminator (Meiki Co., Ltd., MVLP-600). Then, a glass mask with which comb-shaped interconnects as defined by JPCA-ET01 (compliant with JPCA-BU01-2007) can be formed was closely attached to the substrate on which the dry resist film had been laminated, and the resist was exposed to light with energy of 70 mJ by an exposure apparatus at a central wavelength of 405 nm. The exposed substrate was sprayed with 1% Na₂CO₃ aqueous solution at a spray pressure of 0.2 MPa to perform development. Then, the substrate was washed with water and dried to form a resist pattern for use in the subtractive process on the electrodeposited copper film.

The substrate having the resist pattern formed thereon was immersed in an aqueous solution of FeCl₃/HCl (etching solution) at a temperature of 40° C. to perform etching to thereby remove the electrodeposited copper film which was present in the areas where the resist pattern was not formed. Then, the substrate was sprayed with a 3% NaOH aqueous solution at a spray pressure of 0.2 MPa to swell and peel off the resist pattern, neutralized with a 10% aqueous sulfuric acid solution and washed with water to obtain comb-shaped interconnects (electrodeposited patterned copper film). The resulting interconnects had a line width of 20 μm and a space of 75 μm.

### Example 11

In the formation of the layer to be plated in Example 1, exposure of the whole surface was replaced by pattern exposure through laser irradiation and the unexposed portions were then removed by development with 1% aqueous sodium bicarbonate solution to obtain a patterned layer to be plated. [Application of Catalyst] and [Plating] performed in Example 1 was performed on the resulting patterned layer to be plated to obtain the electrodeposited patterned copper film on the plated layer.

### DESCRIPTION OF SYMBOLS

What is claimed is:

1. A composition for forming a layer to be plated, comprising: a compound represented by formula (1): 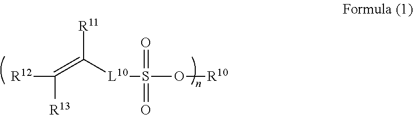
(In formula (1), R¹⁰ represents a hydrogen atom, a metal cation or a quaternary ammonium cation, L¹⁰ represents a single bond or a divalent organic group, R¹¹ to R¹³ each independently represent a hydrogen atom or an optionally substituted alkyl group, and n represents 1 or 2); and a polymer having a polymerizable group.

2. The composition for forming the layer to be plated according to claim 1, wherein a weight ratio between a weight (weight A) of the compound and a total weight of the weight (weight A) of the compound and a weight (weight B) of the polymer (weight A+weight B) {weight A/(weight A+weight B)} is from 0.01 to 0.25.

3. The composition for forming the layer to be plated according to claim 1, wherein a weight ratio between a weight (weight A) of the compound and a total weight of the weight (weight A) of the compound and a weight (weight B) of the polymer (weight A+weight B) {weight A/(weight A+weight B)} is from 0.05 to 0.20.

4. The composition for forming the layer to be plated according to claim 1, further comprising a polyfunctional monomer.

5. The composition for forming the layer to be plated according to claim 1, further comprising a polymerization initiator.

6. A process for producing a laminate having a metal film comprising:
a layer forming step including contacting the composition for forming the layer to be plated according to claim 1 with a substrate and then applying energy to the composition for forming the layer to be plated to form the layer to be plated on the substrate;
a catalyst applying step including applying an electroless plating catalyst or its precursor to the layer to be plated; and
a plating step including subjecting the plating catalyst or its precursor to electroless plating to form the metal film on the plated layer.

7. The process for producing the laminate having the metal film according to claim 6, wherein a surface of the substrate has a water contact angle of up to 80°.

8. A layer to be plated obtained using the composition for forming the layer to be plated according to claim 1.

9. The composition for forming the layer to be plated according to claim 2, wherein the weight ratio between the weight (weight A) of the compound and the total weight of the weight (weight A) of the compound and the weight (weight B) of the polymer (weight A+weight B) {weight A/(weight A+weight B)} is from 0.05 to 0.20.

10. The composition for forming the layer to be plated according to claim 2, further comprising a polyfunctional monomer.

11. The composition for forming the layer to be plated according to claim 2, further comprising a polymerization initiator.

12. A process for producing a laminate having a metal film comprising:
a layer forming step including contacting the composition for forming the layer to be plated according to claim 2 with a substrate and then applying energy to the composition for forming the layer to be plated to form the layer to be plated on the substrate;
a catalyst applying step including applying an electroless plating catalyst or its precursor to the layer to be plated; and
a plating step including subjecting the plating catalyst or its precursor to electroless plating to form the metal film on the plated layer.

13. A layer to be plated obtained using the composition for forming the layer to be plated according to claim 2.

14. The composition for forming the layer to be plated according to claim 3, further comprising a polyfunctional monomer.

15. The composition for forming the layer to be plated according to claim 3, further comprising a polymerization initiator.

16. A process for producing a laminate having a metal film comprising:
a layer forming step including contacting the composition for forming the layer to be plated according to claim 3 with a substrate and then applying energy to the composition for forming the layer to be plated to form the layer to be plated on the substrate;
a catalyst applying step including applying an electroless plating catalyst or its precursor to the layer to be plated; and
a plating step including subjecting the plating catalyst or its precursor to electroless plating to form the metal film on the plated layer.

17. A layer to be plated obtained using the composition for forming the layer to be plated according to claim 3.

18. The composition for forming the layer to be plated according to claim 4, further comprising a polymerization initiator.

19. A process for producing a laminate having a metal film comprising:
a layer forming step including contacting the composition for forming the layer to be plated according to claim 4 with a substrate and then applying energy to the composition for forming the layer to be plated to form the layer to be plated on the substrate;
a catalyst applying step including applying an electroless plating catalyst or its precursor to the layer to be plated; and
a plating step including subjecting the plating catalyst or its precursor to electroless plating to form the metal film on the plated layer.

20. A layer to be plated obtained using the composition for forming the layer to be plated according to claim 4.
